(19) United States
(12) Patent Application Publication
(10) Pub. No.: US 2023/0365739 A1
(43) Pub. Date: Nov. 16, 2023

(54) CURABLE COMPOSITION AND CURED ARTICLE THEREOF

(71) Applicant: TOKUYAMA CORPORATION, Shunan-shi, Yamaguchi (JP)

(72) Inventors: Yasutomo SHIMIZU, Tsukuba-shi (JP); Kazuishi FUKUDA, Tsukuba-shi (JP); Takayoshi KAWASAKI, Tsukuba-shi (JP)

(73) Assignee: TOKUYAMA CORPORATION, Shunan-shi, Yamaguchi (JP)

(21) Appl. No.: 18/019,153

(22) PCT Filed: Aug. 4, 2021
(86) PCT No.: PCT/JP2021/028904

§ 371 Date: Feb. 1, 2023

(30) Foreign Application Priority Data
Aug. 5, 2020 (JP) 2020-133194
Dec. 23, 2020 (JP) 2020-213894
Jan. 29, 2021 (JP) 2021-012699

(51) Int. Cl. C08G 18/42; C08G 18/12; B24B 37/22; B24B 37/24; C09K 9/02; C08G 18/64; C08K 7/22; C08G 18/08; C08G 18/32

(52) U.S. Cl. CPC C08G 18/42; C08G 18/12; B24B 37/22; B24B 37/24; C09K 9/02; C08G 18/64; C08K 7/22; C08G 18/14; C08G 18/3243; C08K 2201/003; C08G 2101/00

(57) ABSTRACT

The present invention relates to a curable composition containing (A) a side chain-containing cyclic molecule in which three or more side chains each having a polymerizable functional group introduced at a terminal are introduced ((A) cyclic polyfunctional monomer), and (B) a polymerizable monomer having a polymerizable functional group polymerizable with the side chain-containing cyclic molecule ((B) another polymerizable monomer). The present invention provides a curable composition from which a cured article having high abrasion resistance and enabling exhibition of excellent mechanical properties and photochromic properties is obtained. In particular, the present invention can provide a curable composition from which a cured article suitable for use as a polishing pad or a photochromic spectacle lens can be obtained.

### TECHNICAL FIELD

The present invention relates to a novel curable composition containing a side chain-containing cyclic molecule in which three or more side chains each having a polymerizable functional group introduced at a terminal are introduced, and a novel cured article obtained from the curable composition.

### BACKGROUND ART

In recent years, a polyrotaxane has attracted attention as a compound having a novel structure. The polyrotaxane is a functional material having a complex molecular structure composed of an axial molecule and a plurality of cyclic molecules surrounding the axial molecule. The polyrotaxane is used in various fields such as semiconductor field and optical material field due to characteristics thereof.

For example, a polyurethane resin is used for a polishing member used in flattening a member to be polished by a polishing agent (see PTL 1).

Specifically, the polyurethane resin is suitably used as a polishing pad for a chemical mechanical polishing (CMP) method of supplying a slurry (polishing solution) in which abrasive grains are dispersed in an alkali solution or an acid solution, and performing polishing during polishing processing.

As polishing properties of the polishing pad in the CMP method, the polishing pad is required to be excellent in flatness of the member to be polished and to have a large polishing rate (polishing velocity). Further, in order to improve productivity, abrasion resistance is desired to be improved.

Therefore, it is disclosed that excellent polishing properties can be exhibited by using the polyrotaxane as a raw material of the polyurethane resin in the polishing pad described above (see PTL 2).

On the other hand, a photochromic spectacle lens as an optical material quickly develops color in an outdoor irradiated with light containing UV rays such as sunlight to function as sunglasses, and fades color in an indoor where there is no irradiation of such light to function as an ordinary transparent spectacle. Generally, a photochromic compound is added to a base material of a spectacle lens or a coating material applied on a surface of the spectacle lens, thereby exhibiting functions.

This photochromic spectacle lens is desired to have excellent photochromic properties (coloring density and fading speed).

Therefore, it is disclosed that by using the polyrotaxane as a raw material of a resin for the photochromic spectacle lens, it is possible to achieve both improvement in mechanical strength due to cross-linking of the polyrotaxane and excellent photochromic properties (coloring density and fading speed) due to the presence of a free space around the polyrotaxane (see PTL 3).

### CITATION LIST

### Patent Literature

PTL 1: JP 2007-77207 A

PTL 2: WO 2018/092826

PTL 3: WO 2015/068798

### SUMMARY OF INVENTION

### Technical Problem

However, in recent years, there has been a demand for further performance improvement, especially in ease of handling, and the polishing pad is required to have excellent mechanical properties while being excellent in flatness (prevention of edge sag) and abrasion resistance of the member to be polished, the photochromic spectacle lens is required to have more excellent photochromic properties, and there is room for improvement in the related art using a polyrotaxane.

In addition, the polyrotaxane described above has room for improvement in terms of a specific structure thereof, for example, the polyrotaxane tends to have a high molecular weight, has poor handleability, and has limitations in production.

Accordingly, an object of the present invention is to provide a curable composition from which a cured article having high abrasion resistance, enabling exhibition of excellent mechanical properties and photochromic properties, and having a good appearance is obtained. In particular, an object of the present invention is to provide a curable composition from which a cured article suitable for use as a polishing pad or a photochromic spectacle lens can be obtained.

### Solution to Problem

The present inventors have conducted diligent studies in order to solve the above problems. As a result of studies by the present inventors in order to solve the above problems, the present inventors have found that by using a curable composition containing a side chain-containing cyclic molecule in which three or more side chains each having a polymerizable functional group introduced at a terminal are introduced, handleability is good, and a cured article having excellent mechanical properties can be obtained by curing the curable composition. Therefore, the present invention has been completed.

That is, according to a first aspect of the present invention,

a curable composition contains: (A) a side chain-containing cyclic molecule in which three or more side chains each having a polymerizable functional group introduced at a terminal are introduced (hereinafter, the side chain-containing cyclic molecule is also referred to as an “(A) component” or an “(A) cyclic polyfunctional monomer”); and (B) a polymerizable monomer having a polymerizable functional group polymerizable with the side chain-containing cyclic molecule (hereinafter, the polymerizable monomer is also referred to as a “(B) component” or a “(B) another polymerizable monomer”).

A second aspect of the present invention is a polishing pad made of a cured article obtained by curing the curable composition according to the first aspect of the present invention.

A third aspect of the present invention is a photochromic cured article obtained by curing the curable composition according to the first aspect of the present invention that further contains a photochromic compound.

The present invention relates to the following [1] to [18].
[1] A curable composition containing: (A) a side chain-containing cyclic molecule in which three or more side chains each having a polymerizable functional group introduced at a terminal of the side chain are introduced ((A) cyclic polyfunctional monomer); and (B) a polymerizable monomer having a polymerizable functional group polymerizable with the side chain-containing cyclic molecule ((B) another polymerizable monomer).
[2] The curable composition according to [1], in which a content of the (A) side chain-containing cyclic molecule in which three or more side chains each having a polymerizable functional group introduced at a terminal are introduced is 2 to 70 parts by mass with respect to 100 parts by mass in total of the (A) side chain-containing cyclic molecule in which three or more side chains each having a polymerizable functional group introduced at a terminal are introduced and the (B) polymerizable monomer having a polymerizable functional group polymerizable with the side chain-containing cyclic molecule.
[3] The curable composition according to [1] or [2], in which the side chains of the (A) side chain-containing cyclic molecule in which three or more side chains each having a polymerizable functional group introduced at a terminal are introduced have a molecular weight of 300 or more in terms of number average molecular weight.
[4] The curable composition according to any one of [1] to [3], in which the (A) side chain-containing cyclic molecule in which three or more side chains each having a polymerizable functional group introduced at a terminal are introduced has a cyclic molecule selected from the group consisting of a cyclodextrin and calix resorcinarene.
[5] The curable composition according to any one of [1] to [4], in which the (A) side chain-containing cyclic molecule in which three or more side chains each having a polymerizable functional group introduced at a terminal are introduced has a viscosity at 60° C. of 500 mPa·s to 50,000 mPa·s.
[6] The curable composition according to any one of [1] to [5], in which the polymerizable functional group in the (A) side chain-containing cyclic molecule in which three or more side chains each having a polymerizable functional group introduced at a terminal are introduced comprises a group selected from the group consisting of a hydroxy group, a thiol group, and an amino group, and the (B) polymerizable monomer having a polymerizable functional group polymerizable with the side chain-containing cyclic molecule comprises a polymerizable monomer containing (B1) an iso(thio)cyanate compound having at least two iso(thio)cyanate groups in a molecule.
[7] The curable composition according to [6], in which the (B1) iso(thio)cyanate compound having at least two iso(thio)cyanate groups in a molecule comprises an iso(thio)cyanate compound containing (B12) a urethane prepolymer having an iso(thio)cyanate group at both terminals of a molecule, the (B12) urethane prepolymer being obtained by reacting (B32) a bifunctional active hydrogen-containing compound having two active hydrogen-containing groups in a molecule with (B13) a bifunctional iso(thio)cyanate compound having two iso(thio)cyanate groups in a molecule.
[8] The curable composition according to [7], in which the (B12) urethane prepolymer has an iso(thio)cyanate equivalent of 300 to 5,000.
[9] The curable composition according to any one of [1] to [8], further containing: (D) fine hollow particles.
[10] The curable composition according to [9], in which the (D) fine hollow particles are fine hollow particles including an outer shell portion selected from the group consisting of a urethane resin and a melamine resin.
[11] A cured article obtained by curing the curable composition according to any one of [1] to [10].
[12] The cured article according to [11], in which the cured article is a foamed cured article.
[13]A polishing pad containing the cured article according to [11] or [12].
[14] A CMP laminated polishing pad using the cured article according to [12] for a polishing layer and/or an underlayer.
[15] A CMP laminated polishing pad using the cured article according to [11] for an underlayer.
[16] The curable composition according to any one of [1] to [8], further containing: (E) a photochromic compound.
[17] The curable composition according to [16], in which the photochromic compound is a compound having one or more structures selected from the group consisting of a naphthopyran, a spirooxazine, a spiropyran, a fulgide, a fulgimide, and a diarylethene.
[18] The curable composition according to [16] or [17], in which the polymerizable functional group in the (A) side chain-containing cyclic molecule in which three or more side chains each having a polymerizable functional group introduced at a terminal are introduced is a group selected from the group consisting of a hydroxy group, a thiol group, an amino group, an acrylic group, a methacrylic group, an allyl group, and a vinyl group.
[19] A photochromic cured article obtained by curing the curable composition according to any one of [16] to [18].

### Advantageous Effects of Invention

The curable composition according to the present invention is excellent in handleability and exhibits excellent mechanical properties and excellent photochromic properties. Further, when the curable composition is applied to a polishing pad, excellent abrasion resistance and an excellent polishing rate can be exhibited, and the appearance is also good. When the curable composition is applied to a photochromic cured article, it is possible to obtain a cured article that exhibits excellent photochromic properties in terms of coloring density and fading speed, and that has a good appearance.

### DESCRIPTION OF EMBODIMENTS

A curable composition according to the present invention is a curable composition containing (A) a cyclic polyfunctional monomer and (B) another polymerizable monomer.

Hereinafter, components for use in the present invention will be described.

### (A) Cyclic Polyfunctional Monomer

As described above, the (A) cyclic polyfunctional monomer is (A) a side chain-containing cyclic molecule in which three or more side chains each having a polymerizable functional group introduced at a terminal are introduced. That is, the (A) cyclic polyfunctional monomer contains a cyclic molecule and three or more side chains introduced into the cyclic molecule, and each side chain has a polymerizable functional group introduced at a terminal. The (A) cyclic polyfunctional monomer is preferably composed of only a cyclic molecule and three or more side chains introduced into the cyclic molecule and having a polymerizable functional group at a terminal.

First, the cyclic molecule used for the (A) cyclic polyfunctional monomer will be described. The cyclic molecule is not particularly limited as long as the cyclic molecule is a cyclic molecule into which a side chain having a polymerizable functional group introduced at a terminal can be introduced. Examples of such a cyclic molecule include a cyclodextrin, crown ether, benzocrown, dibenzocrown, dicyclohexanocrown, cyclobis(paraquat-1,4-phenylene), dimethoxy pillararene, calixarene, calix resorcinarene, and phenanthroline. Among them, a cyclodextrin and calix resorcinarene are preferable, and a cyclodextrin is most preferable.

Examples of the cyclodextrin include an a-cyclodextrin (inner annular diameter of 0.45 nm to 0.6 nm), a β-cyclodextrin (inner annular diameter of 0.6 nm to 0.8 nm), and a γ-cyclodextrin (inner annular diameter of 0.8 nm to 0.95 nm). In addition, a mixture of these cyclodextrins can also be used. In the present invention, an α-cyclodextrin and a β-cyclodextrin are particularly preferable, and a β-cyclodextrin is most preferable in view of cost and physical properties.

The calix resorcinarene is a cyclic molecule obtained by subjecting resorcinol and various aldehydes to cyclocondensation reaction. The resorcinol is not limited to resorcinol, and for example, resorcinol derivatives such as 2-nitroresorcinol may be used. Known aldehydes can be used as the aldehydes without any limitation, and examples of the aldehydes include aliphatic aldehydes such as n-butanal, isobutanal, and heptanal, and aromatic aldehydes such as benzaldehyde, vanillin, and 4-nitrobenzaldehyde, and two or more of the above may be used in combination. Among them, heptanal, benzaldehyde, and vanillin are suitably used. In the present invention, it is preferable that the calix resorcinarene is a tetramer, but is not limited thereto.

Next, the side chains each having a polymerizable functional group introduced at a terminal in the cyclic molecule will be described. In the cyclic molecule used for the cyclic polyfunctional monomer according to the present invention, three or more side chains each having a polymerizable functional group introduced at a terminal are introduced.

The side chains each having a polymerizable functional group introduced at a terminal can be introduced by, for example, using a reactive functional group in the cyclic molecule and modifying the reactive functional group (that is, the side chains are introduced by being reacted with the reactive functional group).

Examples of the reactive functional group include a hydroxy group and an amino group, and among them, a hydroxy group is preferable. For example, a β-cyclodextrin contains 21 hydroxy groups (OH groups) as the reactive functional group, and side chains are introduced by reacting with the OH groups. Therefore, at most 21 side chains can be introduced to one β-cyclodextrin. In the present invention, in order to sufficiently exhibit functions of the side chains described above, three or more side chains each having a polymerizable functional group introduced at a terminal are required to be introduced. The cyclic molecule is preferably a cyclic molecule in which 5 or more side chains each having a polymerizable functional group introduced at a terminal are introduced, more preferably, a cyclic molecule in which 7 or more side chains each having a polymerizable functional group introduced at a terminal are introduced, and most preferably, a cyclic molecule in which 8 or more side chains each having a polymerizable functional group introduced at a terminal are introduced. An upper limit is not particularly limited, but when the number of introduction is too large, the viscosity of the cyclic polyfunctional monomer may be high, and handleability may decrease. Therefore, it is particularly preferable that the side chains are introduced in the range of 8 to 18.

The side chains are not particularly limited, and are preferably formed by repetitions of an organic chain having 3 to 20 carbon atoms. The number average molecular weight of such side chains is preferably 300 or more, for example. More specifically, the number average molecular weight of such side chains is 300 to 10,000, preferably 350 to 5,000, more preferably 400 to 5,000, and most preferably 400 to 1,500. Hardness and physical properties of a cured article obtained when the number average molecular weight falls within this range can be easily adjusted. The number average molecular weight of the side chains can be adjusted by an amount to be used at the time of introduction of the side chains, can be obtained by calculation, and can also be obtained by measurement of ¹H-NMR.

By setting a lower limit of the number average molecular weight of the side chains as described above, excellent mechanical properties are exhibited, and when a cured article obtained by curing the curable composition according to the present invention is used as a polishing pad, a polishing rate tends to be improved. In addition, when the cured article is used for a photochromic spectacle lens, inhibition caused by a reversible reaction of a photochromic compound tends to be prevented. Further, compatibility with the (B) another polymerizable monomer tends to be improved. On the other hand, by setting an upper limit of the number average molecular weight of the side chains as described above, the hardness of the cured article does not decrease, and the abrasion resistance tends not to decrease.

The (A) cyclic polyfunctional monomer preferably has a certain viscosity range. By doing so, the (A) cyclic polyfunctional monomer may have excellent handleability. As a preferable viscosity range, a viscosity at 60° C. is preferably 500 mPa·s to 50,000 mPa·s, more preferably 500 mPa·s to 10,000 mPa·s, and most preferably 1,000 mPa·s to 6,000 mPa·s. These viscosities can be obtained by, for example, a rotational viscometer.

Further, when the molecular weight of the (A) cyclic polyfunctional monomer is too large, handling tends to be difficult and the compatibility also tends to be poor when the (A) cyclic polyfunctional monomer is mixed with other components, for example, the (B) another polymerizable monomer. From this viewpoint, the weight average molecular weight Mw of the (A) cyclic polyfunctional monomer is in the range of 1,500 to 100,000, particularly 2,000 to 30,000, particularly preferably 2,500 to 10,000, and most preferably 3,000 to 8,000. In order to exhibit stable physical properties, the degree of dispersion is preferably 1.2 or less. The weight average molecular weight Mw and the degree of dispersion are values measured by GPC measurement method described in Examples to be described later. The degree of dispersion is a value obtained by dividing the weight average molecular weight by the number average molecular weight.

As described above, when the molecular weight of the (A) cyclic polyfunctional monomer is too large, the handling and the compatibility tend to be poor, and therefore, the (A) cyclic polyfunctional monomer preferably does not form a complex with other molecules.

In the present invention, the side chains as described above may be linear or branched. Regarding the introduction of the side chains, a method or a compound disclosed in WO 2015/159875 can be appropriately used, for example, ring-opening polymerization, radical polymerization, cationic polymerization, anionic polymerization, and living radical polymerization such as atom transfer radical polymerization, RAFT polymerization, or NMP polymerization can be used. By the above-described methods, a side chain having an appropriate size can be introduced by reacting a selected appropriately compound with the reactive functional group in the cyclic molecule.

For example, in the ring-opening polymerization, a side chain derived from a cyclic compound such as a cyclic ether, a cyclic siloxane, a cyclic lactone, a cyclic lactam, a cyclic acetal, a cyclic amine, a cyclic carbonate, a cyclic imino ether, and a cyclic thiocarbonate can be introduced.

Among the cyclic compounds, a cyclic ether, a cyclic lactone, and a cyclic lactam are preferably used from the viewpoint of high reactivity and easy adjustment of the molecular weight.

In a side chain introduced by ring-opening polymerization of a cyclic compound such as a cyclic lactone or a cyclic ether, a hydroxy group is introduced into a terminal of the side chain, and in a side chain introduced by ring-opening polymerization of a cyclic lactam, an amino group is introduced into a terminal of the side chain.

Hereinafter, examples of the cyclic ether, the cyclic lactone, the cyclic lactam, and the cyclic carbonate, which are suitably used, will be shown.

Cyclic ether:

ethylene oxide, 1,2-propylene oxide, epichlorohydrin, epibromohydrin, 1,2-butylene oxide, 2,3-butylene oxide, isobutylene oxide, oxetane, 3-methyloxetane, 3,3-dimethyloxetane, tetrahydrofuran, 2-methyltetrahydrofuran, 3-methyltetrahydrofuran, and the like

Cyclic lactone:

4-membered ring lactones: β-propiolactone, β-methyl propiolactone, L-seline-β-lactone, and the like

5-membered ring lactones: γ-butyrolactone, γ-hexanolactone, γ-heptanolactone, γ-octanolactone, γ-decanolactone, γ-dodecanolactone, α-hexyl-γ-butyrolactone, α-heptyl-γ-butyrolactone, α-hydroxy-γ-butyrolactone, γ-methyl-γ-decanolactone, α-methylene-γ-butyrolactone, α,α-dimethyl-γ-butyrolactone, D-erythronolactone, α-methyl-γ-butyrolactone, γ-nonanolactone, DL-pantolactone, γ-phenyl-γ-butyrolactone, γ-undecanolactone, γ-valerolactone, 2,2-pentamethylene-1,3-dioxolan-4-one, α-bromo-γ-butyrolactone, γ-crotonolactone, α-methylene-γ-butyrolactone, α-methacryloyloxy-γ-butyrolactone, α-methacryloyloxy-γ-butyrolactone, and the like

6-membered ring lactones: δ-valerolactone, δ-hexanolactone, δ-octanolactone, δ-nonanolactone, δ-decanolactone, δ-undecanolactone, δ-dodecanolactone, δ-tridecanolactone, δ-tetradecanolactone, DL-mevalonolactone, 4-hydroxly-1-cyclohexanecarboxylic acid δ-lactone, monomethyl-δ-valerolactone, monoethyl-δ-valerolactone, monohexyl-δ-valerolactone, 1,4-dioxan-2-one, 1,5-dioxepan-2-one, and the like

7-membered ring lactones: ε-caprolactone, monomethyl-ε-caprolactone, monoethyl-ε-caprolactone, monohexyl-ε-caprolactone, dimethyl-ε-caprolactone, di-n-propyl-ε-caprolactone, di-n-hexyl-ε-caprolactone, trimethyl-ε-caprolactone, triethyl-ε-caprolactone, tri-n-ε-caprolactone, ε-caprolactone, 5-nonyl-oxepan-2-one, 4,4,6-trimethyl-oxepan-2-one, 4, 6, 6-trimethyl-oxepan-2-one, 5-hydroxymethyl-oxepan-2-one, and the like

8-membered ring lactones: ζ-enantholactone, and the like

Other lactones: lactones, lactides, dilactides, tetramethyl glycosides, 1,5-dioxepan-2-one, t-butyl caprolactone, and the like

Cyclic lactam:

4-membered ring lactams: 4-benzoyloxy-2-azetidinone, and the like

5-membered ring lactams: γ-butyrolactam, 2-azabicyclo(2,2,1)hept-5-en-3-one, 5-methyl-2-pyrrolidone, and the like

6-membered ring lactams: ethyl 2-piperidone-3-carboxylate, and the like

7-membered ring lactams: ε-caprolactam, DL-α-amino-ε-caprolactam, and the like

8-membered ring lactams: co-heptalactam, and the like

Cyclic carbonate:

ethylene carbonate, propylene carbonate, carbonate 1,2-butylene glycerol 1,2-carbonate, 4-(methoxymethyl)-1,3-dioxolan-2-one, (chloromethyl) ethylene carbonate, vinylene carbonate, 4,5-dimethyl-1,3-dioxol-2-one, 4-chloromethyl-5-methyl-1,3-dioxo1-2-one, 4-vinyl-1,3-dioxolan-2-one, 4, 5-diphenyl-1,3-dioxolan-2-one, 4, 4-dimethyl-5-methylene-1,3-dioxolan-2-one, 1,3-dioxan-2-one, 5-methyl-5-propyl-1,3-dioxolan-2-one, and 5,5-diethyl-1,3-dioxolan-2-one

These cyclic compounds described above may be used alone or in combination of two or more thereof.

In the present invention, the cyclic compound to be suitably used is a lactone compound or a lactam compound. A particularly suitable lactone compound is, for example, ε-caprolactone, α-acetyl-γ-butyrolactone, α-methyl-γ-butyrolactone, γ-valerolactone, and γ-butyrolactone, a particularly suitable lactam compound is ε-caprolactam, γ-butyrolactam, and DL-α-amino-ε-caprolactam, and a most preferable cyclic compound is ε-caprolactone and ε-caprolactam.

When the side chain is to be introduced by reacting the cyclic compound through ring-opening polymerization, a functional group (for example, a hydroxy group) in the cyclic molecule has poor reactivity, and it may be difficult to directly react a large molecule due to steric hindrance in particular. In such a case, in order to react the above-described caprolactone or the like, for example, a method of once reacting a low molecular weight compound such as propylene oxide with a reactive functional group in a cyclic molecule to perform hydroxypropylation, and introducing a functional group having sufficient reactivity in advance is suitable. Thereafter, means of introducing a side chain by ring-opening polymerization using the above-described cyclic compound can be employed. In this case, a hydroxypropylated portion can also be regarded as a side chain.

Any known catalyst can be used without any limitation in the ring-opening polymerization described above. For example, organic titanium compounds such as tetramethyl titanate, tetraethyl titanate, tetrapropyl titanate, and tetrabutyl titanate, organic tin compounds such as tin 2-ethylhexanoate, dibutyltin dilaurate, tin octylate, dibutyltin oxide, and dibutyltin acetate, stannous halide compounds such as stannous chloride, stannous bromide, and stannous iodide, acetylacetonate compounds of various metals, and organic carboxylic acid metal salts can be used. When the above-described catalyst remains in a certain amount after introduction of the side chain, the catalyst may function when cured with the (B) another polymerizable monomer, and the curing may be too early to cause a curing failure. Therefore, the amount of the remaining catalyst is preferably 5,000 ppm or less with respect to the (A) cyclic polyfunctional monomer in terms of various metals used for the catalyst. The amount is more preferably 1,000 ppm or less, and most preferably 600 ppm or less. The amount of the remaining catalytic metal can be measured by ICP emission described in Examples to be described later.

A method of introducing a side chain into a cyclic molecule through radical polymerization is as follows. The cyclic molecule may not have an active site serving as a radical starting point. In this case, prior to causing a radical polymerizable compound to react, it is necessary to react a compound for forming a radical starting point at a functional group (for example, a hydroxy group) in the cyclic molecule to form an active site as a radical starting point.

As the compound for forming a radical starting point as described above, an organic halogen compound is typical. Examples of the organic halogen compound include 2-bromoisobutyryl bromide, 2-bromobutyric acid, 2-bromopropionic acid, 2-chloropropionic acid, 2-bromoisobutyric acid, epichlorohydrin, epibromohydrin, and 2-chloroethyl isocyanate. That is, these organic halogen compounds are bonded to the cyclic molecule by a reaction with a functional group in the cyclic molecule, and a group containing a halogen atom (hereinafter, also referred to as an “organic halogen compound residue”) is introduced into the cyclic molecule. During radical polymerization, a radical is generated in the organic halogen compound residue by the movement of the halogen atom or the like, which is a radical polymerization starting point, and the radical polymerization proceeds.

In addition, the above-described organic halogen compound residue may be introduced by, for example, reacting a compound having a functional group such as amine, isocyanate, and imidazole with the hydroxy group in the cyclic molecule, introducing another functional group other than the hydroxy group, and reacting the above-described organic halogen compound with the another functional group.

As a radical polymerizable compound to be used for introducing a side chain through radical polymerization, a compound having at least one functional group such as a group having an ethylenically unsaturated bond, for example, a (meth)acrylate group, a vinyl group, and a styryl group (hereinafter, also referred to as an “ethylenically unsaturated monomer”) is suitably used. As the ethylenically unsaturated monomer, an oligomer or a polymer having a terminal ethylenically unsaturated bond may also be used. As such an ethylenically unsaturated monomer, suitable specific examples of the ethylenically unsaturated monomer are described in WO 2015/068798.

In the present invention, a reaction of reacting a functional group in the side chain with another compound to introduce a structure derived from the another compound may be referred to as “modification”. A compound for use in modification can be freely used as long as the compound is capable of reacting with, in particular, the functional group in the side chain. By selecting the compound, various polymerizable functional groups can be introduced into the side chain.

As can be understood from the above description, regarding the side chain introduced into the cyclic molecule, the polymerizable functional group may be introduced into the terminal of the side chain by various methods.

The polymerizable functional group is not particularly limited as long as the polymerizable functional group is a group that can be polymerized with the (B) another polymerizable monomer. Examples of the polymerizable functional group include a hydroxy group, an amino group, a thiol group, an epoxy group, an isocyanate group, and a radically polymerizable group. Among them, in the present invention, a preferable polymerizable functional group is a polymerizable functional group selected from the group consisting of a hydroxy group, a thiol group, an amino group, a (meth)acrylic group, an allyl group, and a vinyl group, and a particularly preferable polymerizable functional group is at least one polymerizable functional group selected from the group consisting of a hydroxy group, an amino group, and a (meth)acrylic group.

The (A) cyclic polyfunctional monomer which can be used most suitably in the present invention is a cyclic polyfunctional monomer in which the cyclic molecule is a β-cyclodextrin, the side chain has an introduced hydroxypropyl group, and a polycaprolactone chain obtained by ring-opening polymerization of ε-caprolactone is introduced.

A method of producing the (A) cyclic polyfunctional monomer is not particularly limited, and it is preferable to first introduce a hydroxypropyl group to a hydroxy group in the β-cyclodextrin with propylene oxide, and then introduce a polycaprolactone chain obtained by ring-opening polymerization of ε-caprolactone to the hydroxypropyl group. In this case, the above-described catalyst or an organic solvent can be used, and it is more preferable to perform synthesis without a solvent in terms of convenience and cost. By performing the synthesis without a solvent, the amount of a metal catalyst can also be reduced, and not only a solvent cost and a time for distilling off of the solvent, but also a cost for removing a catalyst such as tin is not required, which is remarkably useful in industrial production. In particular, when the amount of the metal catalyst is increased, a reaction activity is high and a high molecular weight compound is likely to be generated, and therefore the amount of the metal catalyst is preferably 10,000 ppm or less, and most preferably 1,000 ppm or less with respect to the amount of total compounds (ε-caprolactone and β-cyclodextrin introduced with a hydroxypropyl group) used in the production of the (A) cyclic polyfunctional monomer.

### (B) Another Polymerizable Monomer

In the present invention, any known compound can be used without any limitation as long as the (B) another polymerizable monomer is a polymerizable monomer having a polymerizable functional group polymerizable with the (A) cyclic polyfunctional monomer. Of course, the compound is a polymerizable monomer other than the (A) cyclic polyfunctional monomer. Examples of the compound include polymerizable monomers described in WO 2015/068798.

The (B) component for use in polymerization by a successive addition reaction (polycondensation and polyaddition reaction) will be described below.

As the (B) component, when the polymerizable functional group in the (A) cyclic polyfunctional monomer is a group selected from a hydroxy group, a thiol group, and an amino group (the amino group in the present invention refers to both a primary amino group (—NH₂) and a secondary amino group (—NHR, R represents a substituent, for example, an alkyl group)), (B1) an iso(thio)cyanate compound having at least two iso(thio)cyanate groups in a molecule (hereinafter, also referred to as a “(B1) iso(thio)cyanate compound” or a “(B1) component”) can be selected as the (B) component. The iso(thio)cyanate refers to an isocyanate or an isothiocyanate.

When the polymerizable functional group in the (A) cyclic polyfunctional monomer is a hydroxy group or an amino group, (B2) an epoxy group-containing monomer having an epoxy group (hereinafter, also referred to as a “(B2) epoxy group-containing monomer” or a “(B2) component”) can also be selected as the (B) component.

On the other hand, when the polymerizable functional group in the (A) cyclic polyfunctional monomer is an isocyanate group or an isothiocyanate group, the (B) component can be selected from (B3) a (thi)ol compound having at least one group selected from a hydroxy group and a thiol group (hereinafter, also referred to as a “(B3) (thi)ol compound” or a “(B3) component”), and (B4) an amino group-containing monomer having an amino group (hereinafter, also referred to as a “(B4) amino group-containing monomer” or a “(B4) component”).

The curable composition according to the present invention may contain other components in a range where effects of the present invention are not impaired as long as the curable composition contains the (A) component and the (B) component. For example, the curable composition may contain another polymerizable monomer that is not polymerizable with the (A) component and is different from the (B) component (hereinafter, also referred to as a “polymerizable monomer other than (A) and (B)”). Specifically, when the polymerization reaction is a successive addition reaction, by allowing the polymerizable monomer other than (A) and (B) that is not polymerizable with the (A) component but is polymerizable with the (B) component to exist in the curable composition that contains the (A) component and the (B) component polymerizable with the (A) component, the (A) component, the (B) component and the polymerizable monomer other than (A) and (B) can be copolymerized together. That is, in the case of the successive addition reaction, the curable composition can contain not only the (A) component and the (B) component, but also the polymerizable monomer other than (A) and (B) that is copolymerizable with the (B) component.

An example of the successive addition reaction described above will be described in more detail. Specifically, for example, when the polymerizable functional group in the (A) cyclic polyfunctional monomer is an active hydrogen-containing group such as a hydroxy group, the curable composition can contain the (B1) iso(thio)cyanate compound as the (B) another polymerizable monomer, and further, can contain the (B3) (thi)ol compound and the (B4) amino group-containing monomer. In the case of the successive addition reaction, since the (B1) component is contained, a cured article in which the (A) component, the (B1) component, the (B3) component and/or the (B4) component are copolymerized can be obtained. Of course, in this case, the curable composition can further contain the (B2) component.

In the case of the successive addition reaction described above, it is preferable that the components (for example, the (A) component and the (B) component) that react with each other are separately stored before polymerization.

The (B) component for use in chain polymerization will be described below.

When the polymerizable functional group in the (A) cyclic polyfunctional monomer is a radically polymerizable group, the curable composition is composed of a monomer having a radically polymerizable group. In the case of radical polymerization, since the radical polymerization is chain polymerization, the (B) component contained in the curable composition is preferably composed of a monomer having a radically polymerizable group, unlike in the successive addition reaction. Specifically, as (B5) a monomer having a radically polymerizable group (hereinafter, also referred to as a “radically polymerizable monomer” or a “(B5) component”), the (B) component is preferably selected from a (meth)acrylate compound having a (meth)acrylate group and an allyl compound, and is particularly preferably selected from a (meth)acrylate compound. In the present invention, the term “(meth)acrylate group” refers to both a “methacrylate group” and an “acrylate group”.

As described above, the case of the successive addition reaction and the case of the chain polymerization are described, and when both of these can be performed, the following operations can also be performed.

For example, when the polymerizable functional group in the (A) cyclic polyfunctional monomer has both an active hydrogen-containing group such as a hydroxy group and a radically polymerizable group, the (B) component may be only a (meth)acrylate compound having a (meth)acrylate group, an allyl compound or the like as the (B5) component, and when the (B1) component is contained as the (B) component, the component (B) can also contain the (B2) component, the (B3) component, the (B4) component, and the (B5) component.

Hereinafter, regarding the (B) component, the components will be described in detail.

### (B1) Iso(Thio)Cyanate Compound; (B1) Component

The (B1) iso(thio)cyanate compound is a compound having at least two groups selected from the group consisting of an isocyanate group and an isothiocyanate group. Of course, a compound having two groups, i.e., an isocyanate group and an isothiocyanate group, is also selected. Among them, a compound having 2 to 6 iso(thio)cyanate groups in a molecule is preferable, a compound having 2 to 4 iso(thio)cyanate groups in a molecule is more preferable, and a compound having 2 to 3 iso(thio)cyanate groups in a molecule is still more preferable.

The (B1) iso(thio)cyanate compound may be (B12) a urethane prepolymer having an iso(thio)cyanate group at both terminals of a molecule (hereinafter, also referred to as a “(B12) component”), which is produced by a reaction of (B13) a bifunctional iso(thio)cyanate compound having two groups selected from the group consisting of an isocyanate group and an isothiocyanate group in a molecule (hereinafter, also referred to as a “(B13) component”) described below and (B32) a bifunctional active hydrogen-containing compound having two active hydrogen-containing groups in a molecule (hereinafter, also referred to as a “(B32) component”) described below. The (B12) urethane prepolymer corresponding to the (B1) component is a generally used urethane prepolymer having two or more unreacted isocyanate groups or isothiocyanate groups, and can be used in the present invention without any limitation, and the (B12) urethane prepolymer preferably has two or more isocyanate groups.

The active hydrogen-containing groups in the (B32) component are groups selected from a hydroxy group, a thiol group, and an amino group. As specific examples of the (B32) component, those illustrated for the (B3) (thi)ol compound and the (B4) amino group-containing monomer to be described below can be used.

If broadly categorized, the (B1) iso(thio)cyanate compound can be broadly categorized into an aliphatic isocyanate, an alicyclic isocyanate, an aromatic isocyanate, an isothiocyanate, other isocyanates, and the (B12) urethane prepolymer. As the (B1) component, one type of compound may be used, and a plurality of types of compounds may be used. When a plurality of types of compounds are used, a mass to be a standard is the total amount of the plurality of types of compounds. Specific examples of the (B1) component are shown below.

Aliphatic Isocyanate; (B1) Component

Bifunctional isocyanates (corresponding to the (B13) component constituting the (B12) urethane prepolymer to be described in detail below) such as ethylene diisocyanate, trimethylene diisocyanate, tetramethylene diisocyanate, hexamethylene diisocyanate, octamethylene diisocyanate, nonamethylene diisocyanate, 2,2′-dimethylpentane diisocyanate, 2,2,4-trimethylhexamethylene diisocyanate, decamethylene diisocyanate, butene diisocyanate, 1,3-butadiene-1,4-diisocyanate, 2,4,4-trimethylhexamethylene diisocyanate, 1,6,11-trimethylundecamethylene diisocyanate, 1,3,6-trimethylhexamethylene diisocyanate, 1,8-diisocyanate -4-isocyanate methyloctane, 2,5,7-trimethyl-1, 8-diisocyanate-5-isocyanate methyloctane, bis(isocyanatoethyl) carbonate, bis(isocyanatoethyl) ether, 1,4-butylene glycol dipropylether-ω,ω′-diisocyanate, lysine diisocyanate methyl ester, and 2,4,4-trimethylhexamethylene diisocyanate.

Alicyclic isocyanate; (B1) component

Bifunctional isocyanates (corresponding to the (B13) component constituting the (B12) urethane prepolymer to be described in detail below) such as isophorone diisocyanate, icyclo [2.2.1] heptane -2,5-diylkismethylene diisocyanate, (bicyclo [2.2.1]heptane 2,6-diyl)bismethylene diisocyanate, 2β, 5α-bis(isocyanate) norbornane, 2β, 5β-bis(isocyanate) norbornane, 2β, 6α-bis(isocyanate) norbornane, 2β, 6β-bis(isocyanate) norbornane, 2,6-di(isocyanate)furan, bis(isocyanatomethyl)cyclohexane, dicyclohexylmethane-4,4′-diisocyanate, 4,4-isopropylidene bis(cyclohexyl isocyanate), cyclohexane diisocyanate, methylcyclohexane diisocyanate, dicyclohexyldimethylmethane diisocyanate, 2,2′-dimethyldicyclohexylmethane diisocyanate, bis(4-isocyanate-n-butylidene) pentaerythritol, dimer acid diisocyanate, 2,5-bis(isocyanatomethyl)-bicyclo [2, 2, 1]-heptane, 2,6-bis(isocyanatomethyl)-bicyclo [2,2,1]-heptane, 3,8-bis(isocyanatomethyl)tricyclodecane, 3,9-bis(isocyanatomethyl) tricyclodecane, 4,8-bis(isocyanatomethyl) tricyclodecane, 4,9-bis(isocyanatomethyl) tricyclodecane, 1,5-diisocyanate decalin, 2,7-diisocyanate decalin, 1,4-diisocyanate decalin, 2,6-diisocyanate decalin, bicyclo [4.3.0] nonan-3,7-diisocyanate, bicyclo [4.3.0] nonan-4,8-diisocyanate, bicyclo [2.2.1] heptane -2,5-diisocyanate, bicyclo [2.2.1] heptane-2,6-diisocyanate, bicyclo [222] octane -2,5-diisocyanate, bicyclo [2,2,2] octane -2,6-diisocyanate, tricyclo [5.2.1.0^{2.6}] decane -3,8-diisocyanate, and tricyclo [5.2.1.0^{2.6}] decane -4,9-diisocyanate.

Polyfunctional isocyanates such as 2-isocyanatomethyl-3-(3-isocyanatopropyl)-5-isocyanatomethyl-bicyclo[2,2,1]-heptane, 2-isocyanatomethyl-3-(3-isocyanatopropyl)-6-isocyanatomethyl-bicyclo[2,2,1]-heptane, 2-isocyanatomethyl-2-(3-isocyanatopropyl)-5-isocyanatomethyl-bicyclo [2,2,1]-heptane, 2-isocyanatomethyl-2-(3-isocyanatopropyl) -6-isocyanatomethyl-bicyclo [2,2,1]-heptane, 2-isocyanatomethyl-3-(3-isocyanatopropyl)-5-(2-isocyanatoethyl)-bicyclo [2,2,1]-heptane, 2-isocyanatomethyl-3-(3-isocyanatopropyl)-6-(2-isocyanatoethyl)-bicyclo[2,1,1]-heptane, 2-isocyanatomethyl-2-(3-isocyanatopropyl)-5-(2-isocyanatoethyl)-bicyclo[2,2,1]-heptane, 2-isocyanatomethyl-2-(3-isocyanatopropyl)-6-(2-isocyanatoethyl)-bicyclo [2,2,1]-heptane, and 1,3,5-tris(isocyanatomethyl) cyclohexane.

Aromatic isocyanate; (B1) component

Bifunctional isocyanates (corresponding to the (B13) component constituting the (B12) urethane prepolymer to be described in detail below) such as xylylene diisocyanate (o-, m-, p-), tetrachloro-m-xylylene diisocyanate, methylenedip henyl-4,4′-diisocyanate, 4-chloro-m-xylylene diisocyanate, 4,5-dichloro-m-xylylene diisocyanate, 2,3,5,6-tetrabromo-p -xylylene diisocyanate, 4-methyl-m-xylylene diisocyanate, 4-ethyl-m-xylylene diisocyanate, bis(isocyanatoethyl)benzene, bis(isocyanatopropyl)benzene, 1,3-bis(α,α-dimethyl isocyanatomethyl)benzene, 1,4-bis(α,α-dimethyl isocyanatomethyl)benzene, α,α,α′,α′-tetramethylxylylene diisocyanate, bis(isocyanatobutyl)benzene, bis(isocyanatomethyl)naphthaline, bis(isocyanatomethyl) diphenyl ether, bis(isocyanatoethyl)phthalate, 2,6-di(isocyanatomethyl)furan, phenylene diisocyanate (o-, m-, p-), tolylene diisocyanate, ethylphenylene diisocyanate, isopropylphenylene diisocyanate, dimethylphenylene diisocyanate, diethylphenylene diisocyanate, diisopropylphenylene diisocyanate, trimethylbenzene triisocyanate, benzene triisocyanate, 1, 3, 5-triisocyanate methylbenzene, 1,5-naphthalene diisocyanate, methylnaphthalene diisocyanate, biphenyl diisocyanate, 2,4-tolylene diisocyanate, 2,6-tolylene diisocyanate, 4,4′-dip henylmethane diisocyanate, 2,2′-diphenylmethane diisocyanate, 2, 4′-diphenylmethane diisocyanate, 3, 3′-dimethyldiphenylmethane-4,4′-diisocyanate, bibenzyl-4, 4′ -diisocyanate, bis(isocyanatophenyl) ethylene, 3,3′-dimethoxybiphenyl-4, 4′-diisocyanate, phenyl isocyanate methyl isocyanate, phenyl isocyanate ethyl isocyanate, tetrahydronaphthylene diisocyanate, hexahydrobenzene diisocyanate, hexahydrodiphenylmethane-4, 4′-diisocyanate, diphenylether diisocyanate, ethylene glycol diphenylether diisocyanate, 1,3-propylene glycol diphenylether diisocyanate, benzophenone diisocyanate, diethylene glycol diphenylether diisocyanate, dibenzofuran diisocyanate, carbazole diisocyanate, ethylcarbazole diisocyanate, dichlorocarbazole diisocyanate, 2,4-tolylene diisocyanate, and 2, 6-tolylene diisocyanate.

Polyfunctional isocyanate compounds such as mesitylene triisocyanate, trip henylmethane triisocyanate, polymeric MDI, naphthaline triisocyanate, dip henylmethane -2, 4, 4′-triisocyanate, 3-methyl diphenylmethane -4, 4′, 6-triisocyanate, and 4-methyl-dip henylmethane-2, 3, 4′, 5, 6-pentaisocyanate.

Isothiocyanate; (B1) component

Bifunctional isothiocyanates (corresponding to the (B13) component constituting the (B12) urethane prepolymer to be described in detail below) such as p-phenylene diisothiocyanate, xylylene-1,4-diisothiocyanate, and ethylidyne diisothiocyanate.

Other isocyanates; (B1) component

Examples of the other isocyanates include polyfunctional isocyanates having a biuret structure, a uretdione structure, and an isocyanurate structure (for example, a method for modifying an aliphatic polyisocyanate having a biuret structure, a uretdione structure, and an isocyanurate structure is disclosed in JP 2004-534870 A), which contain diisocyanates such as hexamethylene diisocyanate or tolylene diisocyanate as a main raw material, and polyfunctional isocyanates as adducts with a polyol having three or more functional groups such as trimethylolpropane (disclosed in a publication (“Polyurethane Resin Handbook” edited by Keiji Iwata, and published by The Nikkan Kogyo Shimbun, Ltd. in 1987) or the like).

(B12) Urethane Prepolymer; (B1) component having iso(thio)cyanate group at both terminals

In the present invention, the (B12) urethane prepolymer, which is produced by a reaction between the (B13) component and the (B32) bifunctional active hydrogen-containing compound having two active hydrogen-containing groups in a molecule to be described below, can also be used as the (B1) component.

The (B12) urethane prepolymer is not particularly limited, and as the (B13) component, the following monomers are particularly preferably used. Specifically, 1,5-naphthalene diisocyanate, xylene diisocyanate (o-, m-, p-), 2,4-tolylene diisocyanate, 2,6-tolylene diisocyanate, phenylene diisocyanate (o-, m-, p-), 2,2′-dip henylmethane diisocyanate, 2,4′-dip henylmethane diisocyanate, 4,4′-diphenylmethane diisocyanate, isophorone diisocyanate, 1,3-bis(isocyanatomethyl)cyclohexane, dicyclohexylmethane -4, 4′ -diisocyanate, and (bicyclo[2.2.1]heptane -2, 5(2, 6)-diylkismethylene diisocyanate are preferably used. These compounds are preferably reacted with the (B32) bifunctional active hydrogen-containing compound to form the (B12) component having an isocyanate group and/or an isothiocyanate group at both terminals.

In order for the finally obtained resin to exhibit particularly excellent characteristics, it is preferable to use at least one type of the (B32) bifunctional active hydrogen-containing compound having a molecular weight (number average molecular weight) of 300 to 2,000 to produce the (B12) urethane prepolymer. The active hydrogen-containing group refers to a hydroxy group, a thiol group, or an amino group. Among them, in view of reactivity, the active hydrogen-containing group in the (B32) bifunctional active hydrogen-containing compound is preferably a hydroxy group.

The (B32) bifunctional active hydrogen-containing compound having a molecular weight (number average molecular weight) of 300 to 2,000 may be used in combination of different types of compounds or compounds having different molecular weights. In order to adjust hardness, strength and the like of the finally obtained resin, when the (B12) urethane prepolymer is formed, the (B32) component having a molecular weight (number average molecular weight) of 300 to 2,000 and the (B32) component having a molecular weight (number average molecular weight) of 90 to 300 may be used in combination. In this case, the hardness, strength and the like also depend on the types of the (B32) component and the (B13) bifunctional iso(thio)cyanate compound to be used and the use amounts thereof. When the (B32) component having a molecular weight of 300 to 2,000 is taken as 100 parts by mass, the (B32) component having a molecular weight of 90 to 300 is preferably set to 0 to 50 parts by mass. The (B32) component having a molecular weight of 90 to 300 is more preferably set to 1 to 40 parts by mass. When the curable composition according to the present invention is used as a polishing pad, it is preferable to use the (B12) urethane prepolymer described above. It is more preferable that the (B12) urethane prepolymer is a compound synthesized by combining the (B32) component having a molecular weight (number average molecular weight) of 300 to 2,000 and the (B32) component having a molecular weight (number average molecular weight) of 90 to 300. Regarding the ratio of the (B32) component having a molecular weight (number average molecular weight) of 300 to 2,000 and the (B32) component having a molecular weight (number average molecular weight) of 90 to 300, when the total parts by mass of the (B32) component having a molecular weight (number average molecular weight) of 300 to 2,000 and the (B32) component having a molecular weight (number average molecular weight) of 90 to 300 is 100 parts by mass, the (B32) component having a molecular weight (number average molecular weight) of 300 to 2,000 is preferably 60 to 95 parts by mass, and more preferably 70 to 95 parts by mass.

In the (B12) urethane prepolymer, both terminals of the molecule must be isocyanate groups and/or isothiocyanate groups. Therefore, the (B12) urethane prepolymer is preferably produced in such a range that the total number of moles (n5) of the isocyanate groups and/or the isothiocyanate groups in the (B13) bifunctional iso(thio)cyanate compound and the total number of moles (n6) of the active hydrogen-containing groups (hydroxy groups, thiol groups, or amino groups) in the (B32) bifunctional active hydrogen-containing compound are 1<(n5)/(n6)≤2.3. When two or more types of the (B13) components are used in terminals of the molecule, the number of moles (n5) of the isocyanate group and/or isothiocyanate group is, of course, set to the total number of moles of the isocyanate groups and/or the isothiocyanate groups in the (B13) components. In addition, the number of moles (n6) of the active hydrogen-containing groups in two or more types of the (B32) bifunctional active hydrogen-containing compounds is, of course, set to the total number of moles of active hydrogen of the active hydrogen-containing groups. When the active hydrogen-containing group is a primary amino group, the primary amino group is considered to be 1 mol. That is, in the primary amino group, considerable energy is required for the reaction of a second amino group (—NH) (even in the primary amino group, the second —NH is hard to react). Therefore, in the present invention, even when the (B32) bifunctional active hydrogen-containing compound having a primary amino group is used, the primary amino group can be calculated as 1 mol.

An iso(thio)cyanate equivalent (the total amount of an isocyanate equivalent and/or an isothiocyanate equivalent) of the (B12) urethane prep olymer can be obtained by quantifying the isocyanate groups and/or the isothiocyanate groups in the (B12) urethane prepolymer in accordance with JIS K 7301. The isocyanate groups and/or the isothiocyanate groups can be quantified by the following back titration method. First, the obtained (B12) urethane prepolymer is dissolved in a drying solvent. Next, di-n-butylamine, whose amount is clearly excessive to the amount of the isocyanate groups and/or the isothiocyanate groups in the (B12) urethane prepolymer and which has a known concentration, is added to the drying solvent, and all the isocyanate groups and/or isothiocyanate groups in the (B12) urethane prepolymer and di-n-butylamine are reacted with each other. Then, di-n-butylamine not consumed (not involved in the reaction) is titrated with an acid to obtain the amount of the consumed di-n-butylamine. Since the consumed di-n-butylamine has the same amount as the isocyanate groups and/or the isothiocyanate groups in the (B12) urethane prepolymer, the iso(thio)cyanate equivalent can be obtained. Further, since the (B12) urethane prepolymer is a linear urethane prepolymer having an isocyanate group and/or an isothiocyanate group at both terminals, the number average molecular weight of the (B12) urethane prepolymer is twice the iso(thio)cyanate equivalent. The molecular weight of the (B12) urethane prep olymer is likely to match a value measured by gel permeation chromatography (GPC). For example, when the (B12) urethane prepolymer and the (B13) bifunctional iso(thio)cyanate compound are used in combination, a mixture of both may be measured according to the method described above.

The (B12) urethane prepolymer is not particularly limited, and preferably has an iso(thio)cyanate equivalent of 300 to 5,000, more preferably 350 to 3,000, and particularly preferably 350 to 2,000. The reason for this is not particularly clear, but the following may be considered. That is, it is considered that the (B12) urethane prepolymer having a certain molecular weight reacts with a polymerizable functional group in the (A) side chain-containing cyclic molecule in which three or more side chains each having a polymerizable functional group introduced at a terminal are introduced, so that an operating site of the molecule containing the side chain becomes large and the movement of the molecule itself becomes large, and as a result, recovery with respect to deformation (elastic recovery; low hysteresis) becomes easy. Further, it is considered that due to the use of the (B12) urethane prepolymer, crosslinking points in the resin are dispersed with ease and randomly and uniformly present, thereby exhibiting stable performance. The resin obtained by using the (B12) urethane prepolymer is easily controlled during production. For example, it is considered that the resin can be suitably used in the case of using the curable composition according to the present invention as a polishing pad. This effect is considered to be exhibited even when an average iso(thio)cyanate equivalent of a polyiso(thio)cyanate compound is 300 to 5,000 when the (B12) urethane prepolymer and the (B13) bifunctional iso(thio)cyanate compound are used in combination. However, it is considered that the effect is more remarkable when only the (B12) urethane prepolymer is used.

In a method of producing the (B12) urethane prepolymer for use in the present invention, the (B12) urethane prepolymer having an isocyanate group or isothiocyanate group at both terminals of a molecule may be produced by reacting the (B32) bifunctional active hydrogen-containing compound having two active hydrogen-containing groups such as an hydroxy group, an amino group or a thiol group in a molecule with the (B13) bifunctional iso(thio)cyanate compound. The method is not limited as long as it is possible to obtain a prepolymer having an isocyanate group or an isothiocyanate group at a terminal.

Although as described above, a blending amount of the (B32) bifunctional active hydrogen-containing compound and the (B13) bifunctional iso(thio)cyanate compound, which is preferable for obtaining the (B12) urethane prepolymer, is as follows. Specifically, the number of moles (n5) of the isocyanate groups or the isothiocyanate groups in the (B13) component and the number of moles (n6) of active hydrogen in the (B32) bifunctional active hydrogen-containing compound are preferably in the range of 1<(n5)/(n6)≤2.3.

In addition, in order to produce the urethane prepolymer, it is possible to produce the urethane prepolymer by heating or adding a urethane catalyst as necessary in the reaction.

From the viewpoint of the strength of the resin to be formed and control of the reactivity, most preferable examples of the (B1) component for use in the present invention include alicyclic isocyanates such as isophorone diisocyanate, 1,3-bis(isocyanatomethy)cyclohexane, dicyclohexylmethane-4, 4′-diisocyanate, (bicyclo [2.2.1]heptane -2,5-(2,6)-diyl)bismethylene diisocyanate, aromatic isocyanates such as 2,4-tolylene diisocyanate, 2,6-tolylene diisocyanate, 4,4′-diphenylmethane diisocyanate, and xylylene diisocyanate (o-, m-, p-), polyfunctional isocyanates having a biuret structure, a uretdione structure, and an isocyanurate structure containing diisocyanates such as hexamethylene diisocyanate and tolylene diisocyanate as main raw materials, polyfunctional isocyanates as adducts with a polyol having three or more functional groups, or the (B12) urethane prepolymer.

When the present invention is used in a polishing pad application, the (B1) component is preferably the (B12) urethane prepolymer. It is possible to obtain preferable resin physical properties by using the (B12) urethane prepolymer. In particular, the (B12) urethane prepolymer is preferably a urethane prepolymer containing an aromatic isocyanate, and most preferably a urethane prepolymer containing 2,4-tolylene diisocyanate or 2,6-tolylene diisocyanate.

When the present invention is used in a photochromic cured article application, the (B1) component is preferably an aromatic isocyanate or an alicyclic isocyanate, and particularly preferably an alicyclic isocyanate.

### (B2) Epoxy Group-Containing Monomer; (B2) Component

The epoxy group-containing monomer has an epoxy group in a molecule as a polymerizable functional group.

Such an epoxy compound is broadly categorized into an aliphatic epoxy compound, an alicyclic epoxy monomer, and an aromatic epoxy monomer, and suitable specific examples thereof include those described in WO 2015/068798.

### (B3) (Thi)ol Compound; (B3) Component

The (B3) (thi)ol compound can be used without any limitation as long as the (B3) (thi)ol compound is a compound having two or more groups selected from the group consisting of a hydroxy group and a thiol group in one molecule. Of course, a compound having two groups, i.e., a hydroxy group and a thiol group, is also selected.

If broadly categorized, the (B3) component is broadly categorized into an aliphatic alcohol, an alicyclic alcohol, an aromatic alcohol, a polyester polyol, a polyether polyol, a polycaprolactone polyol, a polycarbonate polyol, a polyacryl polyol, a castor oil-based polyol, a thiol, an OH/SH type polymerizable group-containing monomer, and a polyrotaxane having a hydroxy group and/or a thiol group polymerizable with an isocyanate group. Specific examples thereof include the followings.

Aliphatic alcohol; (B3) component

Bifunctional polyols (corresponding to the (B32) bifunctional active hydrogen-containing compound constituting the (B12) urethane prepolymer) such as ethylene glycol, diethylene glycol, propylene glycol, dipropylene glycol, butylene glycol, 1, 5-dihydroxypentane, 1, 6-dihydroxyhexane, 1, 7-dihydroxyheptane, 1,8-dihydroxyoctane, 1,9-dihydroxynonane, 1,10-dihydroxydecane, 1,11-dihydroxyundecane, 1, 12-dihydroxydodecane, neopentyl glycol, glyceryl monooleate, monoelaidin, polyethylene glycol, 3-methyl-1,5-dihydroxypentane, dihydroxyneopentyl, 2-ethyl-1,2-dihydroxyhexane, and 2-methyl-1, 3-dihydroxypropane.

Polyfunctional polyols such as glycerine, trimethylolethane, trimethylolpropane, ditrimethylolpropane, trimethylolpropane trip olyoxyethylene ether (for example, TMP-30, TMP-60, and TMP-90 manufactured by Nippon Nyukazai Co., Ltd.), butanetriol, 1,2-methyl glucoside, pentaerythritol, dip entaerythritol, trip entaerythritol, sorbitol, erythritol, threitol, ribitol, arabinitol, xylitol, allitol, mannitol, dulcitol, iditol, glycol, inositol, hexanetriol, triglycerol, diglycerol, and triethylene glycol.

Alicyclic alcohol; (B3) component

Bifunctional polyols (corresponding to the (B32) bifunctional active hydrogen-containing compound constituting the (B12) urethane prepolymer) such as hydrogenated bisphenol A, cyclobutanediol, cyclopentanediol, cyclohexanediol, cycloheptanediol, cyclooctanediol, cyclohexanedimethanol, hydroxypropylcyclohexanol, tricyclo[5,2,1,0^{2,6}]decane-dimethanol, bicyclo[4,3,0]-nonanediol, dicyclohexanediol, tricyclo [5, 3, 1, 1^{3,9}]dodecanediol, bicyclo [4, 3, 0]nonanedimethanol, tricyclo [5, 3, 1, 1^{3,9}]dodecane-diethanol, hydroxypropyl tricyclo [5, 3, 1, 1^{3,9}]dodecanol, spiro [3, 4]octanediol, butylcyclohexanediol, 1,1′-bicyclohexylidenediol, 1,4-cyclohexanedimethanol, 1,3-cyclohexanedimethanol, 1,2-cyclohexanedimethanol, and o-dihydroxyxylylene.

Polyfunctional polyols such as tris(2-hydroxyethyl) isocyanurate, cyclohexanetriol, sucrose, maltitol, and lactitol.

Aromatic alcohol; (B3) component

Bifunctional polyols (corresponding to the (B32) bifunctional active hydrogen-containing compound constituting the (B12) urethane prepolymer) such as dihydroxynaphthalene, dihydroxybenzene, bisphenol A, bisphenol F, xylylene glycol, tetrabromobisphenol A, bis(4-hydroxyp henyl) methane, 1, 1-bis(4-hydroxyphenyl)ethane, 1, 2-bis(4-hydroxyphenyl)ethane, bis(4-hydroxyphenyl)phenylmethane, bis(4-hydroxyphenyl)diphenylmethane, bis(4-hydroxyphenyl) -1-naphthylmethane, 1, 1-bis(4-hydroxyphenyl)-1-phenylethane, 2-(4-hydroxyp henyl)-2-(3-hydroxyphenyl)propane, 2,2-bis(4-hydroxyphenyl)butane, 1,1-bis(4-hydroxyphenyl)butane, 2, 2-bis(4-hydroxyphenyl)-3-methylbutane, 2,2-bis(4-hydroxyphenyl)pentane, 3, 3-bis(4-hydroxyphenyl)pentane, 2, 2-bis(4-hydroxyphenyl)hexane, 2,2-bis(4-hydroxyphenyl) octane, 2, 2-bis(4-hydroxyphenyl)-4-methylpentane, 2,2-bis(4-hydroxyphenyl)heptane, 4, 4-bis(4-hydroxyphenyl)heptane, 2,2-bis(4-hydroxyphenyl)tridecane, 2,2-bis(4-hydroxyphenyl)octane, 2, 2-bis(3-methyl-4-hydroxyphenyl)propane, 2, 2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2, 2-bis(3-sec-butyl-4-hydroxyphenyl)propane, 2,2-bis(3-tert-butyl-4-hydroxyphenyl)propane, 2,2-bis(3-cyclohexyl-4-hydroxyphenyl)propane, 2,2-bis(3-allyl-4′-hydroxyphenyl)propane, 2,2-bis(3-methoxy-4-hydroxyphenyl)propane, 2,2-bis(3, 5-dimethyl-4-hydroxyphenyl)propane, 2,2-bis(2, 3, 5, 6-tetramethyl-4-hydroxyphenyl)propane, bis(4-hydroxyphenyl)cyanomethane, 1-cyano-3, 3-bis(4-hydroxyphenyl)butane, 2, 2-bis(4-hydroxyphenyl)hexafluoropropane, 1, 1-bis(4-hydroxyphenyl)cyclopentane, 1,1-bis(4-hydroxyphenyl)cyclohexane, 1,1-bis(4-hydroxyphenyl)cycloheptane, 1,1-bis(3-methyl-4-hydroxyphenyl)cyclohexane, 1, 1-bis(3, 5-dimethyl-4-hydroxyphenyl)cyclohexane, 1, 1-bis(3, 5-dichloro -4-hydroxyphenyl)cyclohexane, 1, 1-bis(3-methyl-4-hydroxyphenyl)-4-methylcyclohexane, 1,1-bis(4-hydroxyphenyl)-3, 3, 5-trimethylcyclohexane, 2,2-bis(4-hydroxyphenyl) norbornane, 2,2-bis(4-hydroxyphenyl)adamantane, 4, 4′-dihydroxydiphenyl ether, 4, 4′-dihydroxy-3, 3′-dimethyldiphenyl ether, ethylene glycol bis(4-hydroxyphenyl)ether, 4, 4′-dihydroxydiphenyl sulfide, 3,3′-dimethyl-4,4′-dihydroxydiphenyl sulfide, 3,3′-dicyclohexyl-4, 4′-dihydroxydiphenyl sulfide, 3, 3′ -diphenyl-4, 4′-dihydroxydiphenyl sulfide, 4, 4′-dihydroxydip henyl sulfoxide, 3, 3′-dimethyl-4, 4′-dihydroxydiphenyl sulfoxide, 4, 4′-dihydroxydiphenyl sulfone, 4,4′-dihydroxγ-3,3′-dimethyldiphenyl sulfone, bis(4-hydroxyphenyl)ketone, bis(4-hydroxy-3-methylphenyl)ketone, 7, 7′-dihydroxy-3, 3′, 4, 4′-tetrahydro-4, 4, 4′, 4′-tetramethyl-2, 2′-spirobi(2H-1-benzopyran), trans-2, 3-bis(4-hydroxyphenyl)-2-butene, 9, 9-bis(4-hydroxyphenyl)fluorene, 3, 3-bis(4-hydroxyhenyl) -2-butanone, 1, 6-bis(4-hydroxyphenyl)-1, 6-hexanedione, 4, 4′ -dihydroxybiphenyl, m-dihydroxyxylylene, p-dihydroxyxylylene, 1, 4-bis(2-hydroxyethyl)benzene, 1, 4-bis(3-hydroxypropyl)benzene, 1, 4-bis(4-hydroxybutyl)benzene, 1, 4-bis(5-hydroxypentyl)benzene, 1, 4-bis(6-hydroxyhexyl)benzene, 2, 2-bis[4-(2″-hydroxyethyloxy)phenyl]propane, hydroquinone, and resorcin.

Polyfunctional polyols such as trihydroxynaphthalene, tetrahydroxynaphthalene, benzenetriol, biphenyltetraol, pyrogallol, (hydroxynaphthyl) pyrogallol, and trihydroxyphenanthrene.

Polyester polyol; (B3) component

Examples thereof include compounds obtained by a condensation reaction between a polyol and a polybasic acid. Among them, the number average molecular weight is preferably 400 to 2,000, more preferably 500 to 1,500, and most preferably 600 to 1,200. A compound having a hydroxy group at only both terminals of a molecule (two hydroxy groups in the molecule) corresponds to the (B32) bifunctional active hydrogen-containing compound constituting the (B12) urethane prepolymer.

Here, examples of the polyol include ethylene glycol, 1,2-propanediol, 1,3-butanediol, 1, 4-butanediol, 3-methyl-1,5-p entanediol, 1, 6-hexanediol, 3, 3′-dimethylolheptane, 1, 4-cyclohexanedimethanol, neopentyl glycol, 3,3-bis(hydroxymethyl)heptane, diethylene glycol, dipropylene glycol, glycerine, and trimethylolpropane, and these may be used alone or in combination of two or more thereof. Examples of the polybasic acid include succinic acid, adipic acid, azelaic acid, sebacic acid, dodecanedicarboxylic acid, cyclopentanedicarboxylic acid, cyclohexanedicarboxylic acid, orthophthalic acid, isophthalic acid, terephthalic acid, and naphthalenedicarboxylic acid, and these may be used alone or in combination of two or more thereof.

These polyester polyols are available as reagents or available industrially, and examples of commercially available polyester polyols include “POLYLITE (registered trademark)” series manufactured by DIC Corporation, “NIPPOLLAN (registered trademark)” series manufactured by Nippon Polyurethane Industry Co., Ltd., “MAXIMOL (registered trademark)” series manufactured by Kawasaki Kasei Chemicals Co., Ltd., and “KURARAY POLYOL (registered trademark)” series manufactured by Kuraray Co., Ltd.

Polyether polyol; (B3) component

Examples thereof include compounds obtained by ring-opening polymerization of an alkylene oxide or a reaction of a compound having two or more active hydrogen-containing groups in a molecule with an alkylene oxide, and modified products thereof. Among them, the number average molecular weight is preferably 400 to 2,000, more preferably 500 to 1,500, and most preferably 600 to 1,200. A compound having a hydroxy group at only both terminals of a molecule (two hydroxy groups in the molecule) corresponds to the (B32) bifunctional active hydrogen-containing compound constituting the (B12) urethane prepolymer.

Here, examples of the polyether polyol include a polymer polyol, a urethane-modified polyether polyol, and a polyetherester copolymer polyol. Examples of the compound having two or more active hydrogen-containing groups in a molecule include water, and polyol compounds having one or more hydroxy groups in a molecule such as glycol and glycerine, for example, ethylene glycol, propylene glycol, butanediol, glycerine, trimethylolpropane, hexanetriol, triethanolamine, diglycerine, pentaerythritol, trimethylolpropane, and hexanetriol, and these may be used alone or in combination of two or more thereof.

Further, examples of the alkylene oxide include cyclic ether compounds such as ethylene oxide, propylene oxide, and tetrahydrofuran, and these may be used alone or in combination of two or more thereof.

Such polyether polyols are available as reagents or available industrially, and examples of commercially available polyether polyols include “EXCENOL (registered trademark)” series, and “EMULSTAR (registered trademark)” manufactured by Asahi Glass Co., Ltd., and “ADEKA POLYETHER” series manufactured by ADEKA Corporation.

Polycaprolactone polyol; (B3) component

Examples thereof include compounds obtained by ring-opening polymerization of ε-caprolactone. Among them, the number average molecular weight is preferably 400 to 2,000, more preferably 500 to 1,500, and most preferably 600 to 1,200. A compound having a hydroxy group at only both terminals of a molecule (two hydroxy groups in the molecule) corresponds to the (B32) bifunctional active hydrogen-containing compound constituting the (B12) urethane prepolymer.

The polycaprolactone polyols are available as reagents or available industrially, and examples of commercially available polycaprolactone polyols include “PLACCEL (registered trademark)” series manufactured by Daicel Chemical Industries, Ltd.

Polycarbonate polyol; (B3) component

Examples thereof include compounds obtained by phosgenation of one or more types of low molecular weight polyols, or compounds obtained by transesterification using ethylene carbonate, diethyl carbonate, diphenyl carbonate, or the like. Among them, the number average molecular weight is preferably 400 to 2,000, more preferably 500 to 1,500, and most preferably 600 to 1,200. A compound having a hydroxy group at only both terminals of a molecule (two hydroxy groups in the molecule) corresponds to the (B32) bifunctional active hydrogen-containing compound constituting the (B12) urethane prepolymer.

Here, examples of the low molecular weight polyols include ethylene glycol, 1,2-propanediol, 1,3-propanediol, 2-methyl-1,3-propanediol, 1,2-butanediol, 1,3-butanediol, 1,4-butanediol, 1,5-pentanediol, 1,6-hexanediol, 1,8-octanediol, 1,9-nonanediol, 1,10-decanediol, 3-methyl-1,5-pentanediol, 2-ethyl-4-butyl-1,3-propanediol, diethylene glycol, dipropylene glycol, neopentyl glycol, cyclohexane-1,4-diol, cyclohexane-1,4-dimethanol, dimer acid diol, an ethylene oxide adduct or a propylene oxide adduct of bisphenol A, bis(β-hydroxyethyl)benzene, xylylene glycol, glycerine, trimethylolpropane, and pentaerythritol.

Polyacryl polyol; (B3) component

Examples of the polyacryl polyol include polyol compounds obtained by polymerizing a (meth)acrylate ester or a vinyl monomer. A compound having a hydroxy group at only both terminals of a molecule (two hydroxy groups in the molecule) corresponds to the (B32) bifunctional active hydrogen-containing compound constituting the (B12) urethane prepolymer.

Castor oil-based polyol; (B3) component

Examples of the castor oil-based polyol include polyol compounds using castor oil, which is a natural oil or fat, as a starting material. A compound having a hydroxy group at only both terminals of a molecule (two hydroxy groups in the molecule) corresponds to the (B32) component constituting the (B12) urethane prepolymer.

The castor oil-based polyols are available as reagents or available industrially, and examples of commercially available castor oil-based polyols include “URIC (registered trademark)” series manufactured by Itoh Oil Chemicals Co., Ltd.

Thiol; (B3) component

Suitable specific examples of the thiol include those described in WO 2015/068798 pamphlet. Among them, the following can be given as particularly suitable examples.

Ttetraethylene glycol bis(3-mercaptopropionate), 1,4-butanediol bis(3-mercaptopropionate), 1,6-hexanediol bis(3-mercaptopropionate), and 1, 4-bis(mercaptopropylthiomethyl)benzene (corresponding to the (B32) bifunctional active hydrogen-containing compound constituting the (B12) urethane prepolymer).

Thiols such as trimethylolpropane tris(3-mercaptopropionate), pentaerythritol tetrakis(3-mercaptopropionate), dip entaerythritol hexakis(3-mercaptopropionate), 1, 2-bis [(2-mercaptoethyl)thio]-3-mercaptopropane, 2,2-bis(mercaptomethyl)-1, 4-butanedithiol, 2, 5-bis(mercaptomethyl) -1, 4-dithiane, 4-mercaptomethyl-1, 8-dimercapto-3, 6-dithiaoctane, 1,1,1,1-tetrakis(mercaptomethyl)methane, 1, 1, 3, 3-tetrakis(mercaptomethylthio)propane, 1, 1, 2, 2-tetrakis(mercaptomethylthio)ethane, 4, 6-bis(mercaptomethylthio)-1, 3-dithiane, and tris-{(3-mercaptopropionyloxy)ethyl}-isocyanurate.

OH/SH type polymerizable group-containing monomer; (B3) component

The OH/SH type polymerizable group-containing monomer is a polymerizable monomer having both a hydroxy group and a thiol group.

2-mercaptoethanol, 1-hydroxγ-4-mercaptocyclohexane, 2-mercaptohydroquinone, 4-mercaptop henol, 1-hydroxyethylthio-3-mercaptoethylthiobenzene, 4-hydroxy-4′-mercaptodip henylsulfone, 2-(2-mercaptoethylthio)ethanol, dihydroxyethyl sulfide mono(3-mercaptopropionate), and dimercaptoethane mono(salicylate) (corresponding to the (B32) bifunctional active hydrogen-containing compound constituting the (B12) urethane prepolymer).

Polyfunctional OH/SH type polymerizable group-containing monomers such as 3-mercapto-1,2-propanediol, glycerine di(mercaptoacetate), 2,4-dimercaptophenol, 1,3-dimercapto -2-propanol, 2,3-dimercapto-1-propanol, 1,2-dimercapto-1,3-butanediol, pentaerythritol tris(3-mercaptopropionate), pentaerythritol mono(3-mercaptopropionate), pentaerythritol bis(3-mercaptopropionate), pentaerythritol tris(thioglycolate), pentaerythritol pentakis(3-mercaptopropionate), hydroxymethyl-tris(mercaptoethylthiomethyl)methane, and hydroxyethylthiomethyl-tris(mercaptoethylthio)methane.

Polyrotaxane having hydroxy group and/or thiol group polymerizable with isocyanate group; (B3) component

The polyrotaxane is a molecule complex having a structure in whcih a chain axial molecule passes through rings of a plurality of cyclic molecules and a bulky group is bonded to both ends of the axial molecule such that the cyclic molecules cannot separate from the axial molecule due to steric hindrance, and is also called a supramolecule. The polyrotaxane which can be used as the (B3) component according to the present invention is a polyrotaxane having a hydroxy group and/or a thiol group polymerizable with an isocyanate group. The polyrotaxane having a hydroxy group and/or a thiol group, which can used as the (B3) component according to the present invention, is not particularly limited, and examples thereof include polyrotaxanes described in WO 2018/092826.

### (B4) Amino Group-Containing Monomer; (B4) Component

The (B4) amino group-containing monomer for use in the present invention can be used without any limitation as long as the (B4) amino group-containing monomer is a monomer having two or more primary and/or secondary amino groups in one molecule. If broadly categorized, the amino group-containing monomer is categorized into an aliphatic amine, an alicyclic amine, an aromatic amine, and a polyrotaxane having an amino group polymerizable with an isocyanate group.

Specific examples of the (B4) amino group-containing monomer include the following.

Aliphatic amine; (B4) component

Bifunctional amines (corresponding to the (B32) bifunctional active hydrogen-containing compound constituting the (B12) urethane prepolymer) such as ethylenediamine, hexamethylenediamine, nonamethylenediamine, undecanemethylenediamine, dodecamethylenediamine, metaxylenediamine, 1,3-propanediamine, and putrescine.

Polyfunctional amines such as polyamines, for example, diethylenetriamine.

Alicyclic amine; (B4) component

Bifunctional amines (corresponding to (B32) bifunctional active hydrogen-containing compound constituting the (B12) urethane prepolymer) such as isophoronediamine and cyclohexyldiamine.

Aromatic amines; (B4) component

Bifunctional amines (corresponding to the (B32) bifunctional active hydrogen-containing compound constituting the (B12) urethane prepolymer) such as 4,4′-methylene bis(o-chloroaniline) (MOCA), 2,6-dichloro-p-phenylenediamine, 4, 4′-methylene bis(2, 3-dichloroaniline), 4,4′-methylene bis(2-ethyl-6-methylaniline), 3, 5-bis(methylthio)-2, 4-toluenediamine, 3, 5-bis(methylthio)-2, 6-toluenediamine, 3, 5-diethyltoluene-2, 4-diamine, 3, 5-diethyltoluene-2, 6-diamine, trimethylene glycol-di-p-aminobenzoate, polytetramethylene glycol-di-p-aminobenzoate, 4, 4′-diamino -3, 3′, 5, 5′-tetraethyldiphenylmethane, 4, 4′-diamino-3, 3′-diisopropyl-5, 5′ -dimethyldip henylmethane, 4,4′-diamino -3,3′,5,5′-tetraisopropyldiphenylmethane, 1,2-bis(2-aminop henylthio)ethane, 4,4′-diamino-3,3′-diethyl-5,5′-dimethyldip henylmethane, N, N′-di-sec-butyl-4,4′-diaminodiphenylmethane, 3,3′ -diethyl-4,4′-diaminodiphenylmethane, m-xylylenediamine, N,N′-di-sec-butyl-p-phenylenediamine, m-phenylenediamine, p-xylylenediamine, p-phenylenediamine, 3,3′-methylene bis(methyl-6-aminobenzoate), 2-methylpropyl 2, 4-diamino-4-chlorobenzoate, isopropyl 2,4-diamino-4-chlorobenzoate, isopropyl 2,4-diamino-4-chlorophenylacetate, di-(2-aminophenyl)thioethyl terephthalate, diphenylmethanediamine, tolylenediamine, and piperazine.

Polyfunctional amines such as 1,3,5-benzenetriamine and melamine.

Polyrotaxane having an amino group polymerizable with isocyanate group; (B4) component

The polyrotaxane which can be used as the (B4) component according to the present invention is a polyrotaxane having an amino group polymerizable with an isocyanate group. The polyrotaxane having an amino group, which can be used as the (B4) component according to the present invention, is not particularly limited, and examples thereof include polyrotaxanes described in WO 2018/092826.

When the present invention is used for a polishing pad application, it is preferable to contain the (B4) component. Since a cured article containing the (B4) component has a urea bond, excellent strength is easily exhibited. The (B4) component is preferably an amino group-containing monomer selected from aromatic amines. Further preferable specific examples thereof include 4,4′-methylene bis(o-chloroaniline) (MOCA), 3,5-bis(methylthio)-2,4-toluenediamine, 3, 5-bis(methylthio)-2, 6-toluenediamine, 3, 5-diethyltoluene-2, 4-diamine, and 3, 5-diethyltoluene-2, 6-diamine.

### (B6) Mono(Thi)ol Compound; (B6) Component

For the purpose of adjusting hardness and improving photochromic properties of a photochromic cured article, the curable composition according to the present invention may further contain, as the (B) component, a (B6) mono(thi)ol compound having a hydroxy group or a thiol group in one molecule (hereinafter, also referred to as a “(B6) component”).

In particular, by using the (B6) component in the curable composition to be used for the photochromic cured article, a flexible space is formed around the mono(thi)ol compound, and a reversible structural change of a photochromic compound present in the vicinity of the space is generated more quickly, and thus a photochromic cured article having excellent photochromic properties (coloring density and fading speed) can be obtained.

The (B6) mono(thi)ol compound is a mono(thi)ol compound having a hydroxy group or a thiol group in one molecule as a reactive group.

Examples of the (B6) mono(thi)ol compound include the following.

Compounds having a hydroxy group in one molecule: polyethylene glycol monooleyl ether, polyoxyethylene oleate, polyethylene glycol monolaurate, polyethylene glycol monostearate, polyethylene glycol mono-4-octylphenyl ether, linear polyoxyethylene alkyl ethers (polyethylene glycol monomethyl ether, polyoxyethylene lauryl ether, p olyoxyethylene-2-ethylhexyl ether, polyoxyethylene tridecyl ether, polyoxyethylene cetyl ether, and polyoxyethylene stearyl ether), polypropylene glycol monomethyl ether, glyceryl dioleate, linear or branched saturated alkyl alcohols having 5 to 30 carbon atoms, and the like.

Compounds having a thiol group in one molecule: 3-methoxybutyl thioglycolate, 2-ethylhexyl thioglycolate, 2-mercaptoethyl octanoate, 3-methoxybutyl- 3-mercaptop ropionate, ethyl 3-mercaptopropionate, 2-octyl-3-mercaptopropionate, n-octyl-3-mercaptopropionate, methyl-3-mercaptopropionate, tridecyl-3-mercaptopropionate, stearyl-3-mercaptop rop ionate, saturated alkylthiols having a linear or branched structure and 5 to 30 carbon atoms, and the like.

In the present invention, when the cured article according to the present invention is produced by curing the polymerizable functional group in the (A) component through the successive addition reaction of the active hydrogen-containing groups, the curable composition containing the (A) component, the (B1) component, the (B2) component, the (B3) component, the (B4) component, and the (B6) component to be blended as necessary is preferably blended as follows. When the polymerizable functional group in the (A) component is an active hydrogen-containing group, the (B1) component is essential.

Specifically, with respect to 100 parts by mass in total of the (A) component and the total amount of the (B1) component, the (B2) component, the (B3) component, the (B4) component, and the (B6) component blended as necessary (hereinafter, also referred to as a “(B) component amount”), it is preferable to contain the (A) component in the range of 2 to 70 parts by mass and the (B) component amount in the range of 30 to 98 parts by mass. By containing the (A) component in this ratio, the obtained cured article can exhibit excellent mechanical properties. In addition, it is possible to adjust a preferable range according to applications on use. For example, when the obtained cured article is to be used in a polishing pad application, it is more preferable that the (A) component is contained in the range of 5 to 70 parts by mass and the (B) component amount is in the range of 30 to 95 parts by mass, and it is still more preferable that the (A) component is contained in the range of 10 to 50 parts by mass and the (B) component amount is in the range of 50 to 90 parts by mass. By containing the (A) component and the (B) component amount within such ranges, excellent abrasion resistance and polishing properties can be exhibited. When the obtained cured article is to be used in a photochromic cured article application, it is more preferable that the (A) component is contained in the range of 2 to 50 parts by mass and the (B) component amount is in the range of 50 to 98 parts by mass, and it is still more preferable that the (A) component is contained in the range of 3 to 30 parts by mass and the (B) component amount is in the range of 70 to 97 parts by mass.

Further, in a case where the (B) component amount is set to 100% by mass when the obtained cured article is to be used in the polishing pad application, it is preferable that the (B1) component is set to 0% to 100% by mass, the (B2) component is set to 0% to 100% by mass, the (B3) component is set to 0% to 80% by mass, and the (B4) component is set to 0% to 30% by mass in order to exhibit excellent mechanical properties. In order to further exhibit this effect, it is more preferable that the (B1) component is set to 20% to 95% by mass, the (B2) component is set to 0% to 20% by mass, the (B3) component is set to 0% to 70% by mass, and the (B4) component is set to 0% to 25% by mass. It is more preferable that the (B1) component is set to 40% to 95% by mass, the (B2) component is set to 0% to 5% by mass, the (B3) component is set to 0% to 35% by mass, and the (B4) component is set to 2% to 20% by mass. It is most preferable that the (B1) component is set to 40% to 95% by mass, the (B2) component is set to 0% to 5% by mass, the (B3) component is set to 0% to 35% by mass, and the (B4) component is set to 4% to 20% by mass.

Among the above, in order for the finally obtained cured article to exhibit particularly excellent characteristics, it is preferable to use at least the (B12) urethane prepolymer as the (B1) component. In this case, in a case where the (B) component amount is set to 100% by mass when the obtained cured article is to be used in the polishing pad application, it is preferable that the (B12) component is set to 50% to 90% by mass, the (B1) component other than the (B12) component is set to 0% to 10% by mass, the (B2) component is set to 0% to 5% by mass, the (B3) component is set to 0% to 20% by mass, and the (B4) component is set to 0% to 20% by mass. It is more preferable that the (B12) component is set to 50% to 90% by mass, the (B1) component other than the (B12) component is set to 0% to 10% by mass, the (B2) component is set to 0% to 5% by mass, the (B3) component is set to 0% to 20% by mass, and the (B4) component is set to 2% to 20% by mass. It is most preferable that the (B12) component is set to 50% to 90% by mass, the (B1) component other than the (B12) component is set to 0% to 10% by mass, the (B2) component is set to 0% to 5% by mass, the (B3) component is set to 0% to 20% by mass, and the (B4) component is set to 4% to 20% by mass.

In a case where the (B) component amount is set to 100% by mass when the obtained cured article is to be used in the photochromic cured article application, it is preferable that the (B1) component is set to 0% to 100% by mass, the (B2) component is set to 0% to 100% by mass, the (B3) component is set to 0% to 80% by mass, the (B4) component is set to 0% to 20% by mass, and the (B6) component is set to 0% to 20% by mass in order to exhibit excellent mechanical properties. In order to further exhibit this effect, it is more preferable that the (B1) component is set to 10% to 80% by mass, the (B2) component is set to 0% to 10% by mass, the (B3) component is set to 0% to 75% by mass, the (B4) component is set to 0% to 10% by mass, and the (B6) component is set to 0% to 15% by mass. It is most preferable that the (B1) component is set to 20% to 60% by mass, the

(B2) component is set to 0% to 5% by mass, the (B3) component is set to 0% to 70% by mass, the (B4) component is set to 0% to 20% by mass, and the (B6) component is set to 0% to 10% by mass.

### (B5) Radically Polymerizable Monomer; (B5) Component

In the present invention, the (B5) radically polymerizable monomer is not particularly limited as long as the (B5) radically polymerizable monomer has a radically polymerizable group. In this case, the polymerizable functional group contained in the (A) component is a radically polymerizable group. Then, the curable composition contains at least the (A) component and the (B5) component.

If broadly categorized, the (B5) component can be categorized into a (meth)acrylate compound having a (meth)acrylate group, a vinyl compound having a vinyl group, an allyl compound having an allyl group, and a polyrotaxane having a radically polymerizable group.

Suitable specific examples of the (B5) component include those described in WO 2015/068798.

The polyrotaxane having a radically polymerizable group is not particularly limited, and examples thereof include polyrotaxanes having a radically polymerizable group described in WO 2015/068798 and WO 2018/030257.

In the present invention, when the cured article according to the present invention is produced by curing the polymerizable functional group in the (A) component through radical polymerization of a radically polymerizable group, the curable composition containing the (A) component and the (B5) component is preferably blended as follows.

Specifically, with respect to 100 parts by mass in total of the (A) component and the (B5) component, it is preferable to contain the (A) component in the range of 2 to 70 parts by mass and the (B5) component in the range of 30 to 98 parts by mass. By containing the (A) component in this ratio, the obtained cured article can exhibit excellent mechanical properties. In order to exhibit the above effect, it is more preferable that the (A) component is in the range of 5 to 45 parts by mass and the (B5) component is in the range of 55 to 95 parts by mass.

### Regarding Suitable Curable Composition

The compositions described above for the (A) component and the (B) component are not particularly limited, and can be freely used.

In particular, in a curable composition to be used for a preferable polishing pad material, the polymerizable functional group in the (A) component is preferably selected from the group consisting of a hydroxy group, a thiol group, and an amino group, and the (B) another polymerizable monomer preferably contains the (B1) iso(thio)cyanate compound. By selecting from these, the cured article is a cured article made of a urethane resin.

Among them, the (B1) component is preferably selected from the (B12) urethane prepolymer. By so doing, it is easy to adjust excellent mechanical properties and polishing properties. Among them, in particular, it is preferable that the polymerizable functional group in the (A) component has at least a hydroxy group or an amino group, and the (B1) iso(thio)cyanate compound contained in the (B) another polymerizable monomer contains the (B12) component.

Further, the (B) component preferably contains the (B1) iso(thio)cyanate compound, the (B3) (thi)ol compound and/or the (B4) amino group-containing monomer. In this case, the (B1) component is more preferably the (B12) component. In the present invention, the cured article obtained by curing through the successive addition reaction is a cured article having any one of a urethane bond, a urea bond, a thiourethane bond, and a thiourea bond, or a mixture thereof.

Among them, in a curable composition to be used for a preferable photochromic cured article, the polymerizable functional group in the (A) component is preferably a group selected from the group consisting of a hydroxy group, a thiol group, an amino group, an acrylic group, a methacrylic group, an allyl group, and a vinyl group. Among them, the polymerizable functional group in the (A) component is preferably selected from a hydroxy group, a thiol group, and a (meth)acrylate group. When the polymerizable functional group in the (A) component is a hydroxy group or a thiol group, the (B) another polymerizable monomer preferably contains the (B1) iso(thio)cyanate compound, and when the polymerizable functional group in the (A) component is a (meth)acrylate group, the (B) another polymerizable monomer preferably contains the (B5) radically polymerizable monomer. By selecting from these, the cured article is a cured article made of a urethane resin or a radically polymerizable resin.

When the polymerizable functional group in the (A) component is a hydroxy group or a thiol group, the (B) component preferably contains the (B1) iso(thio)cyanate compound, the (B3) (thi)ol compound and/or the (B6) mono(thi)ol compound.

### Other Blending Components to be Blended in Curable Composition

In the curable composition according to the present invention, various (C) polymerization curing accelerators can also be used in order to quickly promote the curing in accordance with the type of the polymerizable functional group introduced into the (A) component or the (B) component.

For example, when the polymerizable functional group in the (A) component is a hydroxy group, an amino group, an epoxy group, or a thiol group, and the (B) component contains the (B1) iso(thio)cyanate compound, a (C1) reaction catalyst for urethane or urea or a (C2) condensing agent is used as a polymerization curing accelerator.

When the polymerizable functional group in the (A) component is a polymerizable functional group such as a hydroxy group or an amino group, and the (B) component contains the (B2) epoxy group-containing monomer, a (C3) epoxy curing agent or a (C4) cationic polymerization catalyst for ring-opening polymerization of an epoxy group is used as a polymerization curing accelerator.

When the polymerizable functional group in the (A) component is a radically polymerizable group, and the (B) component contains the (B5) radically polymerizable monomer, a (C5) radical polymerization initiator is used as a polymerization curing accelerator.

Specific examples of the (C1) to (C5) polymerization accelerators, which can be suitably used in the present invention, include those described in WO 2015/068798.

The various (C) polymerization curing accelerators may be used alone or in combination of two or more thereof, and a use amount thereof may be a so-called catalytic amount, and may be, for example, in the range of 0.001 to 10 parts by mass, particularly 0.01 to 5 parts by mass per 100 parts by mass in total of the (A) component and the (B) component.

In addition, various known blending agents may be used in the curable composition according to the present invention as long as the effects of the present invention are not impaired. For example, abrasive grains, antioxidants, ultraviolet absorbers, infrared absorbers, coloring inhibitors, fluorescent dyes, dyes, photochromic compounds, pigments, fragrances, surfactants, flame retardants, plasticizers, fillers, antistatic agents, foam stabilizers, solvents, leveling agents, and other additives may be added. These additives may be used alone or in combination of two or more thereof. These additives can be contained in the curable composition, and can be contained in the cured article according to the present invention by curing the curable composition.

As a curing method used in the present invention, known methods may be adopted. In the case of the successive addition reaction, conditions described in WO 2015/068798, WO 2016/143910, and WO 2018/092826 can be adopted. Specifically, a dry method such as a one-pot method and a prepolymer method, a wet method using a solvent, or the like may be used. Among them, a dry method is suitably adopted. In the case of the chain polymerization, conditions described in WO 2014/136804 and WO 2015/068798 are suitably used.

In the present invention, the cured article obtained by curing the curable composition may be a foamed cured article obtained by foaming the cured article. It is only necessary to select whether to use a foamed cured article or a non-foamed cured article according to a desired application, hardness and the like, and it is more preferable that the cured article is a foamed cured article when to be used as a polishing pad in the present invention. Such a foamed cured article can be obtained by a foaming method known in the art, for example, a method of blending a foaming agent or fine particles into the curable composition, or a method of blowing a gas into the curable composition and then curing the curable composition. Examples of a specific method of foaming the cured article include a foaming agent foaming method of adding a volatile foaming agent such as lower boiling hydrocarbons, water or the like, a method of dispersing and curing fine hollow particles (microballoons), a method of mixing thermally expansive fine particles and then heating the mixture to foam the fine particles, or a mechanical froth foaming method of blowing air or an inert gas such as nitrogen gas into a mixture. Among them, preferable are fine hollow particles, which can be suitably used in a case where the cured article according to the present invention obtained when a polishing pad is used as a polishing layer is a foam.

Hereinafter, the fine hollow particles will be described.

### (D) Fine Hollow Particles

As the (D) fine hollow particles (hereinafter, also referred to as a “(D) component”), any known ones can be used without any limitation. Specific examples thereof include particles in which vinylidene chloride resins, (meth)acrylate resins, acrylonitrile and vinylidene chloride copolymers, epoxy resins, phenol resins, melamine resins, urethane resins or the like form an outer shell. Among them, the (D) component is preferably hollow particles composed of an outer shell portion selected from the group consisting of a urethane resin and a melamine resin, and a hollow portion surrounded by the outer shell portion. In the present invention, the urethane resin is a resin having a urethane bond and/or a urea bond. The melamine resin is a resin prepared by polycondensation of melamine and formaldehyde. When these hollow particles are used, a uniform foam can be efficiently and easily produced. Further, when these hollow particles are used, defects such as scratches are less likely to occur, and a hysteresis loss is reduced.

The average particle diameter of the (D) component is not particularly limited, and is preferably in the following ranges. Specifically, the average particle diameter is preferably 1 μm to 500 μm, more preferably 5 μm to 200 μm, and most preferably 10 μm to 100 μm.

The bulk density of the (D) component is not particularly limited, and is preferably in the following ranges. Specifically, the bulk density is preferably 0.01 g/cm³ to 0.5 g/cm³, and more preferably 0.02 g/cm³ to 0.3 g/cm³. The bulk density is a bulk density of the (D) component at the time of expansion. When the (D) component is unexpanded particles and is expanded by heat at the time of curing at a stage of mixing with the curable composition according to the present invention, it is preferable that the bulk density at the time of expansion is the bulk density described above.

A blending amount of the (D) component may be appropriately determined depending on intended applications. Among them, when the obtained cured article is to be used as a polishing pad, the blending amount is preferably as follows. Specifically, the amount of the (D) component is preferably 0.1 to 20 parts by mass, more preferably 0.2 to 10 parts by mass, and still more preferably 0.5 to 8 parts by mass per 100 parts by mass in total of the (A) component and the (B) component.

The density of the cured article in the case of foaming is preferably 0.40 g/cm³ to 0.95 g/cm³. In addition, in a case of using a curable composition containing an iso(thio)cyanate group as a polymerizable functional group, according to a foaming agent foaming method of adding water, water and the iso(thio)cyanate group react with each other, and then carbon dioxide and amino groups are formed; the carbon dioxide is used as a foaming gas, and the amino groups are further reacted with the iso(thio)cyanate group to form a urea bond and/or a thiourea bond.

When the cured article obtained from the curable composition according to the present invention is to be used as a polishing pad, the cured article is preferably a cured article made of a urethane resin, and the cured article can have any suitable hardness. The hardness can be measured according to the Shore method, and can be measured, for example, according to JIS (hardness test) K6253. In the present invention, when the cured article is to be used as a polishing pad, the cured article preferably has Shore hardness of 30A to 70D, and more preferably 40A to 60D (“A” indicates a Shore “A” scale, and “D” indicates hardness on a Shore “D” scale). The hardness can be set to any hardness by changing blending compositions and the blending amount as necessary.

Further, when the cured article obtained from the curable composition according to the present invention is to be used as a polishing pad member, it is preferable that the cured article has a compression ratio in a certain range in order to exhibit flatness of an object to be polished. The compression ratio can be measured by a method according to JIS L 1096. The compression ratio of the cured article is preferably 0.5% to 50%. When the compression ratio is within the above range, excellent flatness of the object to be polished can be exhibited.

When the cured article obtained from the curable composition according to the present invention is to be used as a polishing pad, the hysteresis loss of the cured article is preferably 60% or less, more preferably 50% or less, and still more preferably 40% or less. The hysteresis loss can be measured, for example, by a method according to JIS K 6251. Specifically, a test piece prepared in a dumbbell shape is elongated by 100%, and is then returned to the previous shape, whereby the hysteresis loss (an area of elongation and stress at the time of elongation and returning to the previous shape/an area of elongation and stress at the time of elongation×100) can be measured. It is presumed that by reducing the hysteresis loss, kinetic energy of the abrasive grains can be uniformly used for polishing the object to be polished when the cured article is used as a polishing pad. Therefore, excellent flatness and a high polishing rate can be exhibited. Further, it is considered that by reducing the hysteresis loss, a soft pad can even exhibit an excellent polishing rate. The “area of elongation and stress at the time of elongation and returning to the previous shape” in the measurement of the hysteresis loss described above is represented by “an area of a stress-strain curve at the time of elongation -an area of the stress-strain curve at the time of contraction”, and the “area of elongation and stress at the time of elongation” means the “area of a stress-strain curve at the time of elongation”.

When the cured article obtained from the curable composition according to the present invention is to be used as a polishing pad, the abrasion resistance of the cured article is preferably 60 mg or less, and more preferably 50 mg or less in a Taber abrasion test. When a Taber abrasion loss is reduced, excellent abrasion resistance can be exhibited when the cured article is used as a polishing pad. A detailed method of carrying out the Taber abrasion test can be a method described in Examples to be described later.

In a case of a laminated polishing pad constituting a polishing pad in a plurality of layers, the cured article described above can be used as a member for the polishing pad in at least any one of the layers. For example, when the polishing pad is composed of two layers, the polishing pad has a two-layer structure including a polishing layer (also referred to as a first layer) having a polishing surface that comes into contact with an object to be polished when polishing is performed, and an underlayer (also referred to as a second layer) that is in contact with the first layer on a surface facing the polishing surface of the first layer. In this case, properties of the polishing pad can be adjusted by setting different hardnesses and elastic moduli for the second layer and the first layer. In this case, the hardness of the underlayer is preferably smaller than that of the polishing layer. In the present invention, the cured article described above may be used not only for the polishing layer but also for the underlayer.

The above-described laminated polishing pad is preferably a laminated polishing pad for use in a chemical mechanical polishing (CMP) method.

Examples of the CMP laminated polishing pad include a polishing pad having the two-layer structure including the polishing layer and the underlayer. It is preferable to use the cured article obtained by curing the curable composition according to the present invention for at least one selected from the polishing layer and the underlayer. The cured article may be a foamed cured article or a non-foamed cured article, and is preferably a foamed cured article.

When the cured article is to be used as a polishing pad, the cured article may be a fixed abrasive grain-containing cured article by containing abrasive grains in the curable composition and curing the curable composition. Examples of the abrasive grains include particles of a material selected from cerium oxide, silicon oxide, alumina, silicon carbide, zirconia, iron oxide, manganese dioxide, titanium oxide, and diamond, and two or more types of particles of these materials. A method of containing these abrasive grains is not particularly limited, and for example, these abrasive grains can be contained in the cured article by dispersing these abrasive grains in the curable composition and then curing the curable composition.

In the present invention, the shape of the polishing pad is not particularly limited, and a groove structure may be formed on a surface of the polishing pad. In particular, the groove structure preferably has a shape for retaining and renewing a slurry when a member to be polished is polished. Specifically, examples of the groove structure include an X (stripe) groove, an XY grating groove, a concentric circle-shaped groove, a through hole, a blind hole, a polygonal prism, a cylinder, a spiral groove, an eccentric groove, a radial groove, and a combination of these grooves.

A method of preparing the groove structure is not particularly limited. Examples of the method include a method of performing mechanical cutting with a jig such as a bite having a predetermined size, a preparation method of flowing a resin into a mold having a predetermined surface shape and curing the resin, a preparation method of pressing a resin with a pressing plate having a predetermined surface shape, a preparation method by photolithography, a preparation method by printing means, and a preparation method by laser light using a carbon dioxide laser or the like.

In the present invention, the curable composition may be, for example, applied on or impregnated in a nonwoven fabric, and then cured to form a nonwoven fabric-like polishing pad.

On the other hand, in the present invention, a (E) photochromic compound (hereinafter, also referred to as a “(E) component”) may be blended in the curable composition to obtain a photochromic curable composition. By curing such a photochromic curable composition, a photochromic cured article can be obtained. The photochromic cured article can be suitably used for a photochromic spectacle lens or the like.

The (E) photochromic compound will be described below.

### (E) Photochromic Compound; (E) Component

As the (E) component, any known ones can be used without any limitation, and from the viewpoint of photochromic properties such as coloring density, initial colorability, durability and fading speed, compounds having at least one structure selected from the group consisting of a naphthopyran, a spirooxazine, a spiropyran, a fulgide, a fulgimide, and a diarylethene are preferable, and it is more preferable to use a chromene compound having an indeno[2,1-f]naphtho[1,2-b]pyran skeleton. Among them, particularly a chromene compound having a molecular weight of 540 or more is suitably used because the chromene compound is particularly excellent in coloring density and fading speed.

As the (E) component, the compounds may be used alone or in combination of two or more thereof. A use amount thereof may be appropriately determined according to applications, and for example, it is preferably in the range of 0.001 to 20 parts by mass, and particularly preferably in the range of 0.01 to 10 parts by mass per 100 parts by mass in total of the (A) component and the (B) component.

As a method of obtaining the photochromic cured article by curing the curable composition containing the (E) component, any known methods can be used without any limitation. For example, in the case of curing by the successive addition reaction, conditions described in WO 2015/068798 and WO 2016/143910 are adopted. In the case of the radical polymerization, conditions described in WO 2014/136804 and WO 2015/068798 are adopted.

In addition, the photochromic curable composition can also be used as an adhesive for bonding optical article plates to each other. For example, an optical article including the photochromic cured article according to the present invention can be produced by forming a photochromic curable composition layer by coating one of the optical article plates with the obtained photochromic curable composition, disposing other optical article plates in an overlapping manner to form a predetermined interval such that the photochromic curable composition layer is sandwiched therebetween, and thereafter curing the photochromic curable composition to form an adhesive layer to bond a pair of optical article plates to each other.

According to this method, the thickness of the adhesive layer can be adjusted by adjusting a gap when other optical article plates are disposed in an overlapping manner.

Alternatively, an optical article including the photochromic cured article according to the present invention can be produced by disposing a pair of optical article plates to have a predetermined gap, injecting the photochromic curable composition into the gap between the pair of optical article plates disposed so as to have the predetermined gap, and then curing the photochromic curable composition to form an adhesive layer to bond the pair of optical article plates to each other.

According to this method, when the pair of optical article plates are disposed to have a predetermined gap therebetween, the thickness of the adhesive layer can be adjusted by adjusting the thickness. At this time, it is preferable to adjust the gap between the pair of optical article plates in consideration of slight contraction associated with curing and the like.

In the above case, as a method of adjusting the gap, it is also possible to adjust the interval using an elastomer gasket, an adhesive tape, a spacer or the like.

In addition, it is preferable to sufficiently perform defoaming before curing in any one of the cases where these methods are adopted, and therefore, it is preferable that the photochromic curable composition applied between the pair of optical article plates before curing is in a non-sealed state.

In addition to the polishing pad and the photochromic cured article, the cured article according to the present invention can also be used for a cushioning material, a vibration damping material, a sound absorbing material and the like. In the present invention, a nonwoven fabric-like cured article obtained by coating or impregnating a nonwoven fabric with the curable composition and then curing the nonwoven fabric can be applied not only to the above-described nonwoven fabric-like polishing pad, but also to applications such as a shoe sole, a cushioning material, a vibration damping material, and a sound absorbing material.

### EXAMPLES

Next, the present invention will be described in detail with Examples and Comparative Examples, and the present invention is not limited to Examples. In the following Examples and Comparative Examples, evaluation methods or the like are as follows.

### Measurement Method

(Molecular weight measurement; gel permeation chromatography (GPC measurement))

For the GPC measurement, a liquid chromatograph apparatus (manufactured by Nihon Waters K.K.) was used as an apparatus. According to the molecular weight of a sample to be analyzed, Shodex GPC KF-802 (exclusion limit molecular weight: 5,000), KF802.5 (exclusion limit molecular weight: 20,000), KF-803 (exclusion limit molecular weight: 70,000), KF-804 (exclusion limit molecular weight: 400,000), and KF-805 (exclusion limit molecular weight: 2,000,000) manufactured by Showa Denko K.K. were appropriately used as columns. In addition, dimethylformamide (DMF) was used as a developing solution, and the measurement was performed under conditions of a flow rate of 1 ml/min and a temperature of 40° C. Polystyrene was used as a standard sample, and the weight average molecular weight was obtained by comparison and conversion. A differential refractometer was used as a detector.

(Viscosity measurement)

The viscosity measurement was performed using a Brookfield rotational viscometer (BROOKFIELD RST-CPS Rheometer, manufactured by Eko Instruments Co., Ltd.) under conditions of a shear stress of 100 (Pa) at 60° C.

(Residual tin measurement; ICP emission)

In ICP emission measurement, a sample was dissolved at 1,000 ppm in a mixed solution of methyl isobutyl ketone and isopropyl alcohol, as a solvent, and an amount of metal contained in an extraction solution was calculated using an ICP emission spectrophotometer (i CAP 6500 DUO, manufactured by Thermo Fisher Scientific K.K.).

### Evaluation Method

(1) Density:

The density (g/cm³) was measured using (DSG-1) manufactured by Toyo Seiki Co., Ltd.

(2) D hardness:

The Shore D hardness was measured using a durometer manufactured by Koubunshi Keiki Co., Ltd. according to JIS (hardness test) K6253. The measurement was performed when the thickness was 6 mm in an overlapping manner. The cured article having relatively low hardness was measured in terms of Shore A hardness, and the cured article having relatively high hardness was measured in terms of Shore D hardness.

(3) Abrasion resistance:

The abrasion loss was measured by the Taber abrasion test using a 5130 type apparatus manufactured by TABER Industries. The Taber abrasion test was performed under a load of 1 Kg, a rotational speed of 60 rpm, a rotation number of 1,000 times, an abrasion wheel of H-18, and the abrasion loss was measured.

(4) Hysteresis loss:

A resin punched into a dumbbell shape No. 8 and having a thickness of 2 mm was elongated by 20 mm at 10 mm/min using an AG-SX autograph manufactured by Shimadzu Corporation, and thereafter the hysteresis loss was measured when the stress was returned to zero.

(5) Appearance evaluation of foamed cured article

The total number of appearance failures such as voids exceeding 300 μm in evaluation on surface appearance (one side) of ten prepared polishing pads (each having 500 mmφ)
1: 0 to 2
2: 3 to 5
3: 6 to 10
4: 11 or more.

(6) Polishing rate:

The polishing rate when polishing was performed was measured under the following conditions. The polishing rate (μm/hr) is an average value of ten 2-inch sapphire wafers.

CMP polishing pad: a pad having a size of 500 mm and a thickness of 1 mm, and having a concentric circle-shaped groove on a surface

Slurry: FUJIMI COMPOL 80 stock solution

Pressure: 4 psi

Rotational speed: 45 rpm

Time: 1 hour

(7) Surface roughness (Ra):

Surfaces of the ten 2-inch sapphire wafers at the time of being polished under the condition described in the above (6) were measured for surface roughness (Ra) using a nano search microscope SFT-4500 (manufactured by Shimadzu Corporation). The surface roughness is an average value of the ten 2-inch sapphire wafers.

(8) Appearance evaluation in coating method

An obtained laminate was observed and evaluated using an optical microscope. Evaluation criteria are shown below.

1: The laminate is uniform, and no appearance failure is observed at all.

2: Only slightly fine appearance failure is observed.

3: An appearance failure appears partially.

4: An appearance failure appears entirely.

(9) Maximum absorption wavelength (λmax)

A maximum absorption wavelength after color development was obtained by using a spectrophotometer (instantaneous multi-channel photodetector MCPD 1,000) manufactured by Otsuka Denshi Co. Ltd. The maximum absorption wavelength is related to a color tone at the time of the color development. A table shows an average value.

(10) Coloring density {ε(120)-ε(0)}

A difference between an absorbance {ε(120)} after light irradiation for 120 seconds and an absorbance ε(0) before the light irradiation at the maximum absorption wavelength. It can be said that the higher the coloring density, the more excellent the photochromic properties. In addition, when the color development was performed outdoors, the color tone of the color development was evaluated visually. The table shows an average value.

(11) Fading speed [t½ (sec.)]

A time required for the absorbance at the maximum absorption wavelength of the sample to decrease to ½ of {ε(120)-ε(0)} when the light irradiation is stopped after the light irradiation for 120 seconds. It can be said that the shorter the time is, the more excellent the photochromic properties. The table shows an average value.

(12) Appearance evaluation in bonding method:

The appearance of the photochromic cured article after curing was evaluated according to the following criteria by visually observing the cured article.

1: No problem.

2: A streak defect generated at the time of casting is observed.

(13) Surface roughness (Ra):

Surfaces of the ten 2-inch sapphire wafers at the time of being polished under conditions described below were measured for surface roughness (Ra) using a nano search microscope SFT-4500 (manufactured by Shimadzu Corporation). The surface roughness is an average value of the ten 2-inch sapphire wafers.

Slurry: FUJIMI COMPOL 80 stock solution

Pressure: 4 psi

Rotational speed: 45 rpm

Time: 1 hour

(14) Scratch resistance:

The presence or absence of scratches on 100 2-inch sapphire wafers at the time of being polished under the conditions described in (13) above was confirmed. The evaluation was performed based on the following criteria.
1: The measurement is performed using a laser microscope, and there is no defect on all 100 wafers

12: The measurement is performed using the laser microscope, and defects can be confirmed on 1 to 2 wafers among the 100 wafers
3: The measurement is performed using the laser microscope, and defects can be confirmed on 3 to 5 wafers among the 100 wafers
4: The measurement is performed using the laser microscope, and defects can be confirmed on 6 to 9 wafers among the 100 wafers
5: The measurement is performed using the laser microscope, and defects can be confirmed on 10 or more wafers among the 100 wafers

(15) Edge Sag Property:

Edge sag of the 2-inch sapphire wafers at the time of being polished under the conditions described in (13) above was confirmed. The evaluation was performed based on the following criteria.
1: Edge portions of the wafers are measured using a laser microscope, and the edge sag is within 30 μm
2: The edge portions of the wafers are measured using the laser microscope, and the edge sag is more than 30 μm and 60 μm or less

13: The edge portions of the wafers are measured using the laser microscope, and the edge sag is more than 60 μm and 90 μm or less
4: The edge portions of the wafers are measured using the laser microscope, and the edge sag is more than 90 μm

### Used Components

### Production Example

Production methods of each of the (A) component used in this example are as follows.

(Production of A-1)

A mixed solution obtained by dissolving 10 g of hydroxypropylated α-cyclodextrin (manufactured by CycloChem Co., Ltd.) and 29.6 g of e-caprolactone in 30 g of DMF was stirred at 110° C. while flowing dry nitrogen to the mixed solution, and then 1.19 g of tin (II) 2-ethylhexanoate was added to react for 16 hours. Thereafter, a DMF solution of polycaprolactone-modified cyclodextrin was added dropwise to hexane, decantation was performed, the mixture was further dissolved in acetone and was dropped into water, and then centrifugal separation was performed to obtain a solid. Thereafter, the solid was dissolved in chloroform so as to be 25 wt %, and activated carbon (product number 161551, manufactured by Sigmα-Aldrich Co. LLC) was added in an amount of 20 wt % with respect to a target product, the mixture was stirred overnight and then filtered off, the filtrate was concentrated and dried to obtain a target product A-1. Physical properties of the A-1 were as follows.

Weight average molecular weight Mw (GPC): 3,700

Degree of dispersion (GPC): 1.09

Degree of modification of side chain: 0.49 (49% when represented by %)

Polymerizable group at terminal of side chain: hydroxy group

Number of side chains introduced into cyclic molecule: 8.8

Molecular weight of side chain: about 490 in terms of number average molecular weight

Viscosity: 6,800 mPa·s

Amount of residual tin: 100 ppm

(Production of A-2)

The A-2 was obtained in the same manner as the A-1 except that 59.2 g of ε-caprolactone was used. Physical properties of the A-2 were as follows.

Weight average molecular weight Mw (GPC): 5,700

Degree of dispersion (GPC): 1.10

Degree of modification of side chain: 0.61 (61% when represented by %)

Polymerizable group at terminal of side chain: hydroxy group

Number of side chains introduced into cyclic molecule: 11

Molecular weight of side chain: about 650 in terms of number average molecular weight

Viscosity: 2,800 mPa·s

Amount of residual tin: 200 ppm

(Production of A-3)

The A-3 was obtained in the same manner as the A-1 except that 14.8 g of ε-caprolactone was used. Physical properties of the A-3 were as follows.

Weight average molecular weight Mw (GPC): 2,400

Degree of dispersion (GPC): 1.06

Degree of modification of side chain: 0.39 (39% when represented by %)

Polymerizable group at terminal of side chain: hydroxy group

Number of side chains introduced into cyclic molecule: 7

Molecular weight of side chain: about 330 in terms of number average molecular weight

Viscosity: 47,200 mPa·s

Amount of residual tin: 100 ppm

(Production of A-4)

A mixed solution obtained by dissolving 10.0 g of hydroxypropylated 6-cyclodextrin (manufactured by FUJIFILM Wako Pure Chemical Corporation) and 32.0 g of ε-caprolactonee in DMF was stirred at 110° C. while flowing dry nitrogen to the mixed solution, and then 0.13 g of tin (II) 2-ethylhexanoate was added to react for 10 hours. After the completion of the reaction, the resultant was dissolved in chloroform so as to be 25 wt %, and activated carbon (product number 161551, manufactured by Sigma-Aldrich Co. LLC) was added in an amount of 5 wt % with respect to a target product, and the mixture was stirred overnight. Thereafter, the mixture was filtered off, and the filtrate was concentrated and dried to obtain a target product A-4. Physical properties of the A-4 were as follows.

Weight average molecular weight Mw (GPC): 4,800

Degree of dispersion (GPC): 1.10

Degree of modification of side chain: 0.43 (43% when represented by %)

Polymerizable group at terminal of side chain: hydroxy group

Number of side chains introduced into cyclic molecule: 9

Molecular weight of side chain: about 550 in terms of number average molecular weight

Viscosity: 4,000 mPa·s

Amount of residual tin: 200 ppm

(Production of A-5)

10.0 g of the A-4 prepared as described above was used and dissolved in 50 ml of methyl ethyl ketone, 5 mg of dibutylhydroxytoluene (polymerization inhibitor) was added thereto, and then 2.15 g of 2-acryloyloxyethyl isocyanate was added dropwise. 10 mg of dibutyltin dilaurate was added as a catalyst, and the mixture was stirred at 70° C. for 4 hours to obtain a methyl ethyl ketone solution of cyclodextrin in which an acrylate group was introduced at the terminal of the polycaprolactone. This solution was added dropwise to hexane, and a precipitated solid was collected. The collected sample was spread flat, and was dried at 50° C. under a reduced pressure for 24 hours to obtain A-5 in which an acrylate group was introduced as a radically polymerizable group into a side chain. Physical properties of the A-5 were as follows.

Weight average molecular weight Mw (GPC): 6,000

Degree of dispersion (GPC): 1.10

Degree of modification of side chain: 0.43 (43% when represented by %)

Polymerizable group at terminal of side chain: acrylate group

Number of side chains introduced into cyclic molecule: 9

Molecular weight of side chain: about 680 in terms of number average molecular weight

Viscosity: 5,000 mPa·s

Amount of residual tin: 400 ppm

(Production of A-6)

The A-6 was obtained in the same manner as the A-1 except that the activated carbon treatment was not performed. Physical properties of the A-6 were as follows.

Weight average molecular weight Mw (GPC): 3,700

Degree of dispersion (GPC): 1.09

Degree of modification of side chain: 0.49 (49% when represented by %)

Polymerizable group at terminal of side chain: hydroxy group

Number of side chains introduced into cyclic molecule: 8.8

Molecular weight of side chain: about 490 in terms of number average molecular weight

Viscosity: 6,800 mPa·s

Amount of residual tin: 6,000 ppm

(Production of A-7)

10 g of hydroxypropylated β-cyclodextrin (manufactured by CycloChem Co., Ltd.) and 32.0 g of ε-caprolactone were stirred at 130° C. while flowing dry nitrogen to obtain a homogeneous solution, and then 0.04 g of tin (II) 2-ethylhexanoate was added thereto, and the mixture was reacted for 16 hours to obtain a target product A-7. Physical properties of the A-7 were as follows.

Weight average molecular weight Mw (GPC): 4,800

Degree of dispersion (GPC): 1.05

Degree of modification of side chain: 0.43 (43% when represented by %)

Polymerizable group at terminal of side chain: hydroxy group

Number of side chains introduced into cyclic molecule: 9

Molecular weight of side chain: about 550 in terms of number average molecular weight

Viscosity: 3,800 mPa·s

Amount of residual tin: 300 ppm

(Production of A-8)

The A-8 was obtained in the same manner as the A-7 except that 60.8 g of ε-caprolactonee and 0.07 g of tin (II) 2-ethylhexanoate were used. Physical properties of the A-8 were as follows.

Weight average molecular weight Mw (GPC): 7,800

Degree of dispersion (GPC): 1.06

Degree of modification of side chain: 0.56 (56% when represented by %)

Polymerizable group at terminal of side chain: hydroxy group

Number of side chains introduced into cyclic molecule: 11.8

Molecular weight of side chain: about 770 in terms of number average molecular weight

Viscosity: 2,400 mPa·s

Amount of residual tin: 300 ppm

(Production of A-9)

The A-9 was obtained in the same manner as the A-7 except that 91.3 g of ε-caprolactone and 0.10 g of tin (II) 2-ethylhexanoate were used. Physical properties of the A-9 were as follows.

Weight average molecular weight Mw (GPC): 9,800

Degree of dispersion (GPC): 1.06

Degree of modification of side chain: 0.62 (66% when represented by %)

Polymerizable group at terminal of side chain: hydroxy group Number of side chains introduced into cyclic molecule: 13

Molecular weight of side chain: about 930 in terms of number average molecular weight

Viscosity: 3,600 mPa·s

Amount of residual tin: 300 ppm

(Production of A-10)

The A-10 was obtained in the same manner as the A-7 except that 15.2 g of ε-caprolactone and 0.25 g of tin (II) 2-ethylhexanoate were used. Physical properties of the A-10 were as follows.

Weight average molecular weight Mw (GPC): 3,800

Degree of dispersion (GPC): 1.06

Degree of modification of side chain: 0.31 (31% when represented by %)

Polymerizable group at terminal of side chain: hydroxy group

Number of side chains introduced into cyclic molecule: 6.5

Molecular weight of side chain: about 420 in terms of number average molecular weight

Viscosity: 50,000 mPa·s

Amount of residual tin: 300 ppm

(Production of A-11)

The A-11 was obtained in the same manner as the A-7 except that 0.16 g of tin (II) 2-ethylhexanoate was used. Physical properties of the A-11 were as follows.

Weight average molecular weight Mw (GPC): 4,800

Degree of dispersion (GPC): 1.05

Degree of modification of side chain: 0.43 (43% when represented by %)

Polymerizable group at terminal of side chain: hydroxy group

Number of side chains introduced into cyclic molecule: 9

Molecular weight of side chain: about 550 in terms of number average molecular weight

Viscosity: 3,800 mPa·s

Amount of residual tin: 1,200 ppm

(Production of A-12)

The A-12 was obtained in the same manner as the A-7 except that 182.4 g of ε-caprolactone and 0.19 g of tin (II) 2-ethylhexanoate were used. Physical properties of the A-12 were as follows.

Weight average molecular weight Mw (GPC): 26,000

Degree of dispersion (GPC): 1.14

Degree of modification of side chain: 0.67 (66% when represented by %)

Polymerizable group at terminal of side chain: hydroxy group

Number of side chains introduced into cyclic molecule: 14

Molecular weight of side chain: about 1,820 in terms of number average molecular weight

Viscosity: 10,200 mPa·s

Amount of residual tin: 300 ppm

(Production of A-13)

After 100 g of resorcinol was dissolved in 600 mL of ethanol, 150 mL of hydrochloric acid and 200 mL of a 4.5 mol/L ethanol solution of heptanal were added to a reaction vessel under ice cooling to obtain a homogeneous solution, and then the mixture was reacted at 60° C. for 2 hours. After the completion of the reaction, the mixture was cooled to room temperature, 2,400 mL of water was added thereto, and a precipitated solid was subjected to suction filtration to obtain a crude product. The crude product was recrystallized from methanol to obtain a cyclic tetramer (calix resorcinarene) of resorcinol and heptanal.

92 g of the cyclic tetramer of resorcinol and heptanal, 98 g of ethylene carbonate, and 0.73 g of triphenylphosphine were stirred at 150° C. while flowing dry nitrogen to form a homogeneous solution, and then the mixture was reacted for 3 hours. After the completion of the reaction, the mixture was cooled to 60° C. and was dissolved in 400 mL of methanol, and the cyclic tetramer of resorcinol and heptanal which was hydroxyethylated by recrystallization was obtained.

15.0 g of the hydroxyethylated cyclic tetramer of resorcinol and heptanal and 58.2 g of e-caprolactone were stirred at 130° C. while flowing dry nitrogen form a homogeneous solution, and then 0.07 g of tin (II) 2-ethylhexanoate was added thereto, and the mixture was reacted for 1 hour to obtain a target product A-13. Physical properties of the A-13 were as follows.

Weight average molecular weight Mw (GPC): 5,400

Degree of dispersion (GPC): 1.12

Degree of modification of side chain: 0.93 (93% when represented by %)

Polymerizable group at terminal of side chain: hydroxy group

Number of side chains introduced into cyclic molecule: 7.4

Molecular weight of side chain: about 690 in terms of number average molecular weight

Viscosity: 1,100 mPa·s

Amount of residual tin: 300 ppm

(Production of A-14)

The A-14 was obtained in the same manner as the A-13 except that 20 g of the cyclic tetramer of resorcinol and heptanal and 0.08 g of tin (II) 2-ethylhexanoate were used. Physical properties of the A-14 were as follows.

Weight average molecular weight Mw (GPC): 4,000

Degree of dispersion (GPC): 1.15

Degree of modification of side chain: 0.76 (76% when represented by %)

Polymerizable group at terminal of side chain: hydroxy group

Number of side chains introduced into cyclic molecule: 6.1

Molecular weight of side chain: about 630 in terms of number average molecular weight

Viscosity: 1,100 mPa·s

Amount of residual tin: 300 ppm

(Production of A-15)

After 100 g of resorcinol was dissolved in 600 mL of ethanol, 150 mL of hydrochloric acid and 200 mL of a 5.7 mol/L ethanol solution of vanillin were added to a reaction vessel under ice cooling to obtain a homogeneous solution, and then the mixture was reacted at 60° C. for 2 hours. After the completion of the reaction, the mixture was cooled to room temperature, 2,400 mL of water was added thereto, and a precipitated solid was subjected to suction filtration to obtain a crude product. The crude product was recrystallized from methanol to obtain a cyclic tetramer (calix resorcinarene) of resorcinol and vanillin.

102 g of the cyclic tetramer of resorcinol and vanillin, 98 g of ethylene carbonate, and 0.73 g of triphenylphosphine were stirred at 150° C. while flowing dry nitrogen to form a homogeneous solution, and then the mixture was reacted for 3 hours. After the completion of the reaction, the mixture was cooled to 60° C. and was dissolved in 400 mL of methanol, and the cyclic tetramer of resorcinol and vanillin which was hydroxyethylated by recrystallization was obtained.

15.0 g of the hydroxyethylated cyclic tetramer of resorcinol and vanillin and 45.5 g of ε-caprolactone were stirred at 130° C. while flowing dry nitrogen to form a homogeneous solution, and then 0.06 g of tin (II) 2-ethylhexanoate was added thereto, and the mixture was reacted for 1 hour to obtain a target product

A-15. Physical properties of the A-15 were as follows.

Weight average molecular weight Mw (GPC): 6,100

Degree of dispersion (GPC): 1.15

Degree of modification of side chain: 0.70 (70% when represented by %)

Polymerizable group at terminal of side chain: hydroxy group

Number of side chains introduced into cyclic molecule: 8.4

Molecular weight of side chain: about 550 in terms of number average molecular weight

Viscosity: 1,700 mPa·s

Amount of residual tin: 300 ppm

In addition, the used materials are as follows.

### (B) Another Polymerizable Monomer

(B1) component: iso(thio)cyanate compound
XDI: m-xylylene diisocyanate

(B12) component: urethane prepolymer
Pre-1: urethane prepolymer having isocyanate groups at both terminals of molecule and having iso(thio)cyanate equivalent of 905

(Method of producing Pre-1)

In a flask provided with a nitrogen inlet tube, a thermometer, and a stirrer, 50 g of 2,4-tolylene diisocyanate, 90 g of polyoxytetramethylene glycol (number average molecular weight: 1,000), and 12 g of diethylene glycol were reacted under a nitrogen atmosphere at 80° C. for 6 hours, and a urethane prepolymer having isocyanate groups at both terminals of a molecule and having an iso(thio)cyanate equivalent of 905 was obtained (the Pre-1 was obtained).
Pre-2: urethane prepolymer having isocyanate groups at both terminals of molecule and having iso(thio)cyanate equivalent of 674

(Method of producing Pre-2)

In a flask provided with a nitrogen inlet tube, a thermometer, and a stirrer, 34.8 g of 2,4-tolylene diisocyanate and 100 g of polyoxytetramethylene glycol (number average molecular weight: 1,000) were reacted under a nitrogen atmosphere at 80° C. for 6 hours, and a urethane prepolymer having isocyanate groups at both terminals of a molecule and having an iso(thio)cyanate equivalent of 674 was obtained (the Pre-2 was obtained).
Pre-3: urethane prepolymer having iso(thio)cyanate groups at both terminals of molecule and having iso(thio)cyanate equivalent of 460

(Method of producing Pre-3)

In a flask provided with a nitrogen inlet tube, a thermometer, and a stirrer, 1,000 g of 2,4-tolylene diisocyanate and 1,100 g of polypropylene glycol (number average molecular weight: 500) were reacted under a nitrogen atmosphere at 80° C. for 4 hours, then 120 g of diethylene glycol was added, the mixture was reacted at 80° C. for 5 hours, and a urethane prepolymer having isocyanate groups at both terminals of a molecule and having an iso(thio)cyanate equivalent of 460 was obtained (the Pre-3 was obtained).

(B3) component: (thi)ol compound
Poly#10: castor oil-based polyol having active hydrogen group of 2.8 mmol/g per weight and penta-or hexa-functional hydroxy group (POLYCASTOR #10 manufactured by Itoh Oil Chemicals Co., Ltd.).
PEMP: pentaerythritol tetrakis(3-mercaptopropionate).
TMP: trimethylolpropane
RX-1: active hydrogen group-containing polyrotaxane in which hydroxy group is present in side chain, side chain has average molecular weight of about 350 and weight average molecular weight of 165,000

Method of producing active hydrogen group-containing polyrotaxane

A linear polyethylene glycol (PEG) having a molecular weight of 10,000 was prepared as a polymer for an axial molecule, and 10 g of PEG, 100 mg of TEMPO (2,2,6,6-tetramethyl-1-piperidinyloxy radical), and 1 g of sodium bromide were dissolved in 100 mL of water. 5 mL of an aqueous solution of sodium hypochlorite (effective chlorine concentration: 5%) was added to the solution, and was stirred at room temperature for 10 minutes. Thereafter, 5 mL of ethanol was added and the reaction was completed. Next, extraction was performed using 50 mL of methylene chloride, then methylene chloride was distilled off and dissolved in 250 mL of ethanol, then methylene chloride was reprecipitated at a temperature of −4° C. for 12 hours, and PEG-COOH was recovered and dried.

3 g of the prepared PEG-COOH and 12 g of α-cyclodextrin (α-CD) were separately dissolved in 50 mL of water at 70° C., and the obtained solutions were mixed and shaken well. Next, the mixed solution was reprecipitated for 12 hours at a temperature of 4° C., and a precipitated inclusion complex was lyophilized and collected. Thereafter, 0.13 g of adamantanamine was dissolved in 50 ml of dimethylformamide (DMF) at room temperature, and then the inclusion complex was added and quickly shaken well. Subsequently, a solution obtained by dissolving 0.38 g of a benzotriazole-1-yl-oxy-tris(dimethylamino)phosphonium hexafluorophosphate reagent in 5 mL of DMF was further added and was shaken well. Further, a solution obtained by dissolving 0.14 mL of diisopropylethylamine in 5 mL of DMF was added and was shaken well to obtain a slurry reagent.

The obtained slurry reagent was left to stand at 4° C. for 12 hours. Thereafter, 50 ml of a DMF/methanol mixed solvent (volume ratio: 1/1) was added and mixed, and a supernatant was thrown away by centrifugal separation. Further, cleaning was carried out with the above DMF/methanol mixed solution, and then cleaning by using methanol and centrifugal separation were carried out to obtain a precipitate. The obtained precipitate was dried under vacuum, then the precipitate was dissolved in 50 mL of dimethyl sulfoxide (DMSO), and the obtained transparent solution was added dropwise to 700 mL of water to precipitate a polyrotaxane. The precipitated polyrotaxane was collected by centrifugal separation, and was dried under vacuum. Further, the polyrotaxane was dissolved in DMSO and was precipitated in water, collected, and dried to obtain a purified polyrotaxane. An inclusion amount of α-CD at this time was 0.25.

Here, the inclusion amount was measured using a ¹H-NMR measurement apparatus (JNM-LA500, manufactured by JEOL Ltd.) by dissolving a polyrotaxane in DMSO-d₆, and was calculated by the following method.

Here, X, Y, and X/(Y-X) indicate the following meanings.

X: integral value of hydroxy group-derived proton in cyclodextrin of 4 ppm to 6 ppm

Y: integral value of methylene chain-derived proton in cyclodextrin of 3 ppm to 4 ppm and PEG

X/(Y-X): proton ratio of cyclodextrin to PEG

First, X/(Y-X) at the time of the maximum inclusion amount 1 was theoretically calculated in advance, and the inclusion amount was calculated by comparing this value with X/(Y-X) calculated based on an analysis value of the actual compounds.

500 mg of the above-described purified polyrotaxane was dissolved in 50 mL of a 1 mol/L NaOH aqueous solution, and 3.83 g (66 mmol) of propylene oxide was added thereto, and the mixture was stirred under an argon atmosphere at room temperature for 12 hours. Next, a 1 mol/L HCl aqueous solution was used to neutralize the polyrotaxane solution to have a pH of 7 to 8, and after dialysis with a dialysis tube, the mixture was lyophilized to obtain a hydroxypropylated polyrotaxane. The obtained hydroxypropylated polyrotaxane was identified by ¹-H-NMR and GPC, and it was confirmed that the obtained hydroxypropylated polyrotaxane was a hydroxypropylated polyrotaxane having a desired structure.

The degree of modification to the hydroxy group in the cyclic molecule through the hydroxypropyl group was 0.5, and the weight average molecular weight Mw obtained by GPC measurement was 50,000.

5 g of the obtained hydroxypropylated polyrotaxane was dissolved in 15 g of ε-caprolactone at 80° C. to prepare a mixed solution. This mixed solution was stirred at 110° C. for 1 hour while flowing dry nitrogen being, then 0.16 g of a 50 wt % xylene solution of tin (II) 2-ethylhexanoate was added thereto, and the mixture was stirred at 130° C. for 6 hours. Thereafter, xylene was added to obtain a ε-caprolactone-modified polyrotaxane xylene solution in which a side chain having a nonvolatile concentration of about 35% by mass was introduced.

The ε-caprolactone-modified polyrotaxane xylene solution prepared as described above was added dropwise to hexane, and was collected and dried to obtain an active hydrogen group-containing polyrotaxane (RX-1).

(B4) component: amino group-containing monomer
MOCA: 4,4′-methylene bis(o-chloroaniline)
   HARTCURE 30: mixture of 3,5-diethyltoluene-2,4-diamine and 3,5-diethyltoluene-2,6-diamine (manufactured by KUMIAI CHEMICAL INDUSTRY CO., LTD.).

(B5) component: radically polymerizable monomer
TMPT: trimethylolpropane trimethacrylate
GMA: glycidyl methacrylate
14G: polyethylene glycol dimethacrylate (average chain length of ethylene glycol chain: 14, average molecular weight: 736)
MOPMS: γ-methacryloyloxypropyltrimethoxysilane RX-2: radically polymerizable group-containing polyrotaxane in which acrylate group and OH group (acrylate group/OH group=85 mol %/15 mol %) are
present in side chain, and molecular weight of side chain is about 600 on average, and weight average molecular weight thereof is 880,000

Method of Producing Acrylate Group-Introduced Side Chain-Modified Polyrotaxane Monomer

The active hydrogen-containing polyrotaxane (RX-1) prepared for the (B3) component was used to synthesize a radically polymerizable group-containing polyrotaxane (RX-2). 10.0 g of the active hydrogen-containing polyrotaxane (RX-1) was dissolved in 50 ml of methyl ethyl ketone, 5 mg of dibutylhydroxytoluene (polymerization inhibitor) was added thereto, and then 1.94 g of 2-acryloyloxyethyl isocyanat was added dropwise. 10 mg of dibutyltin dilaurate was added as a catalyst, and the mixture was stirred at 70° C. for 4 hours to obtain a methyl ethyl ketone solution of polyrotaxane in which an acrylate group was introduced at the terminal of the polycaprolactone. This solution was added dropwise to hexane, and a precipitated solid was collected. The collected sample was spread flat, and was dried at 50° C. under a reduced pressure for 24 hours to obtain the polyrotaxane (RX-2) in which an acrylate group was introduced as a radically polymerizable group into a side chain.

(B6) component: mono(thi)ol compound
PGME 10: polyethylene glycol monooleyl ether (n≈10, Mw=668)
STMP: stearyl-3-mercaptopropionate (Mw=359)

### (C) Polymerization Curing Accelerator

Sn1: dimethyltin dichloride, reaction catalyst for urethane or urea
PI: phenyl bis(2,4,6-trimethylbenzoyl)-phosphine oxide (trade name: Irgacure 819, manufactured by BASF corporation), photoradical polymerization initiator

### (D) Fine Hollow Particles

Hollow particles 1: microcapsules 920-40 (manufactured by Japan Fillite Co., Ltd.) being hollow particle and having particle diameter of 40 μm and bulk density of 0.02 g/cm³
Hollow particles 2: urethane resin microballoons being hollow particle and having particle diameter of 30 μm and bulk density of 0.13 g/cm³

(Method of producing hollow particles 2/method of producing urethane resin microballoons)

1,000 g of toluene was added to 650 g of polytetramethylene glycol (number average molecular weight: 2,000), 142 g of isophorone diisocyanate was further added thereto, and the mixture was reacted under a toluene reflux at 120° C. for 5 hours. Then, the mixture was cooled to room temperature, 25 g of hexamethylenediamine and 20 g of diethylenetriamine were added thereto, the mixture was reacted at 60° C. for 5 hours, and then toluene was distilled off under a reduced pressure to obtain a polyurethane resin having hydroxy groups at both terminals and having urethane and urea bonds. 400 g of the obtained resin, 12 g of iron oxide, 62 g of n-hexane, and 380 g of ethyl acetate were mixed, and the mixture was dispersed while being added dropwise to 2,000 g of a 0.5% aqueous solution of polyvinyl alcohol prepared in advance. The obtained resin was taken out from water by filtration through filter paper, and was dried with an air-circulating drier at 40° C. A spherical body was crushed and sieved by a sonic type classifier to obtain urethane microballoons.
Hollow particles 3: melamine resin microballoons being hollow particle and having particle diameter of 30 μm and bulk density of 0.13 g/cm³

(Method of producing hollow particles 3/method of producing melamine resin microballoons)

A (a) component was prepared using 100 parts by mass of toluene alone. Next, 200 parts by mass of water was mixed with 10 parts by mass of polyethylene-maleic anhydride, and the mixed solution was adjusted to a pH of 4 with a 10% aqueous solution of sodium hydroxide to prepare a (b) component. Then, the prepared (a) component and (b) component were mixed, and the mixture was stirred using a high speed shearing type disperser under conditions of 2,000 rpm and 25° C. for 10 minutes to prepare an 0/W emulsion. 9 parts by mass of Nikaresin S-260, i.e., a melamine-formaldehyde prepolymer compound, was added to the prepared O/W emulsion, and the mixture was stirred at 65° C. for 24 hours. Then, the mixture was cooled to 30° C., and then aqueous ammonia was added to the mixture until the pH reached 7.5, to obtain a microballoon dispersion in which a resin film was formed of a melamine resin. The microballoons were taken out from the obtained microballoon dispersion by filtration, and were dried under vacuum at a temperature of 60° C. for 24 hours to obtain hollow microballoons. Thereafter, the hollow microballoons were sieved by a classifier to obtain the hollow particles 3.

### (E) Photochromic Compound

PC1: photochromic compound having the following structure

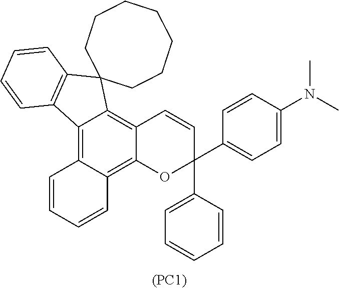

(Others)

### Stabilizer

HALS: bis(1,2,2,6,6-pentamethyl-4-piperidyl) sebacate (molecular weight: 508)

### Leveling Agent

L1: trade name: L7001 manufactured by Dow Corning Toray Co., Ltd.

HP: ethylene bis(oxyethylene) bis[3-(5-tert-butyl-4-hydroxy-m-tolyl)propionate]

### Foam Stabilizer

L5617: silicone foam stabilizer manufactured by Momentive Performance Materials Inc.

### Case of Application to Polishing Pad

### Example 1

23 parts by mass of the A-1 as the (A) component and 5 parts by mass of 4,4′-methylene bis(o-chloroaniline) (MOCA) as the (B4) component were mixed at 120° C. to obtain a homogeneous solution, and then the homogeneous solution was sufficiently degassed to prepare an A solution. Separately, 0.8 parts by mass of the hollow particles 1 as the (D) component was added to 72 parts by mass of the Pre-1 as the (B) component produced as described above and heated to 70° C., and the mixture was stirred with a rotation and revolution type stirrer to prepare a homogeneous solution as a B solution. The A solution was added to the B solution prepared above, and the mixture was uniformly mixed to obtain a curable composition. The curable composition was injected into a mold and was cured at 100° C. for 15 hours. After the completion of curing, a cured article was obtained by being taken out from the mold. The blending amounts are shown in Table 1.

Next, the obtained cured article was sliced to prepare cured articles having a thickness of 2 mm and a thickness of 1 mm. The following physical properties of the cured article having a thickness of 2 mm obtained by slicing were measured. Regarding the obtained cured article, the density was 0.8 g/cm³, the Shore D hardness was 22D, the abrasion resistance was 19 mg, the hysteresis loss was 23%, and the appearance evaluation of the foamed cured article was 1.

Further, a spiral groove was formed on a front surface of the cured article having a thickness of 1 mm obtained by slicing, and a double-sided tape was attached to a back surface to obtain a polishing pad formed of a cured article having a size of 500 mm and a thickness of 1 mm.

The polishing rate of the polishing pad formed of the cured article obtained above was 3.2 μm/hr, the surface roughness after polishing of a wafer, i.e., an object to be polished, was 0.25 nm, and the edge sag thereof was 1. The results are also shown in Table 1.

### Examples 2 to 19, 23 to 29 and Comparative Examples 1 and 2

A cured article and a polishing pad were prepared and evaluated in the same manner as in Example 1 except that compositions shown in Table 1 were used. Results are shown in Table 1.

TABLE 1

| | Curable composition | | | | | Evaluation result | |
|---|---|---|---|---|---|---|---|
| | (A) Component | (B1) Component | (B3) Component | (B4) Component | (D) Component | Density | D |
| | (part by mass) | (part by mass) | (part by mass) | (part by mass) | (part by mass) | (g/cm³) | hardness |
| Example 1 | A-1 (23) | Pre-1 (72) | — | MOCA (5) | Hollow particles 1 (0.8) | 0.80 | 22 |
| Example 2 | A-2 (26) | Pre-1 (69) | — | MOCA (5) | Hollow particles 1 (0.8) | 0.80 | 20 |
| Example 3 | A-3 (19) | Pre-1 (76) | — | MOCA (5) | Hollow particles 1 (0.8) | 0.80 | 24 |
| Example 4 | A-4 (24) | Pre-1 (71) | — | MOCA (5) | Hollow particles 1 (0.8) | 0.80 | 22 |
| Example 5 | A-3 (24) | Pre-1 (71) | — | MOCA (5) | Hollow particles 1 (0.8) | 0.80 | 23 |
| Example 6 | A-4 (30) | Pre-2 (64) | — | MOCA (6) | Hollow particles 1 (0.8) | 0.80 | 32 |
| Example 7 | A-4 (24) | Pre-1 (71) | — | MOCA (5) | Hollow particles 2 (3.3) | 0.90 | 22 |
| Example 8 | A-1 (16) | Pre-1 (77) | — | MOCA (6) | Hollow particles 1 (0.8) | 0.80 | 28 |
| Example 9 | A-1 (7) | Pre-1 (83) | — | MOCA (9) | Hollow particles 1 (0.8) | 0.80 | 40 |
| Example 10 | A-1 (2) | Pre-1 (87) | — | MOCA (11) | Hollow particles 1 (0.8) | 0.80 | 55 |
| Example 11 | A-1 (23) | Pre-1 (72) | — | MOCA (5) | Hollow particles 2 (3.3) | 0.90 | 22 |
| Example 12 | A-6 (23) | Pre-1 (72) | — | MOCA (5) | Hollow particles 1 (0.8) | 0.80 | 22 |
| Example 13 | A-7 (24) | Pre-1 (71) | — | MOCA (5) | Hollow particles 1 (0.8) | 0.80 | 22 |
| Example 14 | A-7 (12) | Pre-1 (82) | — | MOCA (6) | Hollow particles 1 (0.8) | 0.80 | 24 |
| Example 15 | A-8 (20) | Pre-1 (75) | — | MOCA (5) | Hollow particles 1 (0.8) | 0.80 | 22 |
| Example 16 | A-9 (26) | Pre-1 (69) | — | MOCA (5) | Hollow particles 1 (0.8) | 0.80 | 20 |
| Example 17 | A-10 (8) | Pre-1 (86) | — | MOCA (6) | Hollow particles 1 (0.8) | 0.80 | 26 |
| Example 18 | A-11 (24) | Pre-1 (71) | — | MOCA (5) | Hollow particles 1 (0.8) | 0.80 | 22 |
| Example 19 | A-7 (12) | Pre-1 (82) | — | MOCA (6) | Hollow particles 3 (3.3) | 0.90 | 23 |
| Example 23 | A-12 (36) | Pre-3 (53) | — | MOCA (11) | Hollow particles 1 (0.8) | 0.80 | 22 |
| Example 24 | A-7 (29) | Pre-3 (67) | — | MOCA (4) | Hollow particles 1 (0.8) | 0.80 | 23 |
| Example 25 | A-7 (12) | Pre-1 (83) | — | HARTCURE (5) | Hollow particles 1 (0.8) | 0.80 | 24 |
| Example 26 | A-7 (14) | Pre-2 (68) | Poly#10 (18) | — | Hollow particles 1 (0.8) | 0.80 | 23 |
| Example 27 | A-13 (25) | Pre-1 (70) | — | MOCA (5) | Hollow particles 1 (0.8) | 0.80 | 20 |
| Example 28 | A-14 (21) | Pre-1 (74) | — | MOCA (5) | Hollow particles 1 (0.8) | 0.80 | 21 |
| Example 29 | A-15 (19) | Pre-1 (76) | — | MOCA (5) | Hollow particles 1 (0.8) | 0.80 | 23 |
| Comparative | — | Pre-1 (88) | — | MOCA (12) | Hollow particles 1 (0.8) | 0.80 | 60 |
| Example 1 | | | | | | | |
| Comparative | — | Pre-1 (71) | RX-1 (24) | MOCA (5) | Hollow particles 1 (0.8) | 0.80 | 23 |
| Example 2 | | | | | | | |

| | Evaluation result | | | | | |
|---|---|---|---|---|---|---|
| | | | Appearance | | | |
| | Abrasion | | evaluation | | Surface | |
| | resistance | Hysteresis | of foamed | Polishing rate | roughness | Edge sag |
| | (mg) | loss (%) | cured article | (μm/hr) | Ra (nm) | property |
| Example 1 | 19 | 23 | 1 | 3.2 | 0.25 | 1 |
| Example 2 | 19 | 21 | 1 | 3.1 | 0.25 | 1 |
| Example 3 | 38 | 40 | 2 | 2.2 | 0.35 | 2 |
| Example 4 | 18 | 22 | 1 | 3.2 | 0.25 | 1 |
| Example 5 | 35 | 35 | 2 | 2.3 | 0.35 | 2 |
| Example 6 | 30 | 28 | 1 | 2.8 | 0.28 | 1 |
| Example 7 | 15 | 10 | 1 | 4.0 | 0.22 | 1 |
| Example 8 | 27 | 25 | 1 | 3.0 | 0.27 | 1 |
| Example 9 | 41 | 29 | 1 | 2.0 | 0.30 | 1 |
| Example 10 | 50 | 53 | 1 | 1.5 | 0.31 | 2 |
| Example 11 | 15 | 10 | 1 | 4.0 | 0.22 | 1 |
| Example 12 | 19 | 23 | 3 | 3.1 | 0.33 | 3 |
| Example 13 | 18 | 22 | 1 | 3.2 | 0.25 | 1 |
| Example 14 | 22 | 31 | 1 | 3.3 | 0.26 | 1 |
| Example 15 | 24 | 30 | 1 | 3.2 | 0.23 | 1 |
| Example 16 | 24 | 29 | 1 | 3.1 | 0.25 | 1 |
| Example 17 | 41 | 42 | 3 | 2.2 | 0.32 | 2 |
| Example 18 | 18 | 22 | 2 | 3.2 | 0.30 | 2 |
| Example 19 | 22 | 31 | 1 | 3.9 | 0.22 | 1 |
| Example 23 | 29 | 34 | 3 | 2.7 | 0.30 | 2 |
| Example 24 | 25 | 33 | 1 | 2.9 | 0.26 | 1 |
| Example 25 | 30 | 38 | 1 | 3.0 | 0.28 | 1 |
| Example 26 | 30 | 22 | 1 | 2.3 | 0.31 | 2 |
| Example 27 | 25 | 24 | 1 | 2.7 | 0.27 | 1 |
| Example 28 | 26 | 30 | 1 | 2.8 | 0.27 | 1 |
| Example 29 | 23 | 35 | 1 | 3.0 | 0.28 | 1 |
| Comparative | 60 | 70 | 1 | 1.0 | 0.32 | 2 |
| Example 1 | | | | | | |
| Comparative | 20 | 25 | 4 | 3.0 | 0.24 | 3 |
| Example 2 | | | | | | |

### Case of Application to Polishing Pad (Underlayer)

### Example 20

(Method of Producing Underlayer)

13 parts by mass of the A-7 as the (A) component and 2.0 parts by mass of TMP as the (B3) component were mixed at 120° C. to obtain a homogeneous solution, and then the homogeneous solution was sufficiently degassed to prepare an A solution.

Separately, 1.5 parts by mass of L5617 as the another component was added to 85 parts by mass of the Pre-1 as the (B) component heated to 70° C., the mixture was vigorously stirred at 2,000 rpm under a nitrogen atmosphere by using a stirrer including a stirring blade as a beater, and bubbles were taken in by a mechanical frothing method to prepare a B solution. Then, the B solution was poured into the prepared A solution, the mixture was vigorously stirred at 2,000 rpm again under a nitrogen atmosphere by using a stirrer including a stirring blade as a beater, and bubbles were taken in by the mechanical frothing method to obtain a uniform curable composition having a foam structure. The curable composition was injected into a mold and was polymerized at 100° C. for 15 hours. After the completion of the polymerization, the polymerized resin was taken out, and a foamed resin was obtained. The obtained foamed resin was sliced to obtain an underlayer having a thickness of 1.5 mm. The blending amounts are shown in Table 1. Regarding the obtained underlayer, the density was 0.7 g/cm³, the compression ratio was 7%, the D hardness was 16, and the hysteresis loss was 3%.

(Method of Producing Polishing Layer)

The hollow particles 1 (0.8 parts by mass) as the (D) component were added to the Pre-1 (88 parts by mass) as the (B) component produced as described above and heated to 70° C., and the mixture was stirred with a rotation and revolution type stirrer to prepare a homogeneous solution. Then, 4,4′-methylene bis(o-chloroaniline) (MOCA) (12 parts by mass) heated at 120° C. was added thereto, and the mixture was uniformly mixed to obtain a curable composition. The curable composition was injected into a mold and was cured at 100° C. for 15 hours. After the completion of curing, a urethane (urea) resin was taken out from the mold to obtain a cured article.

The obtained cured article was sliced to obtain a urethane resin having a thickness of 1 mm. A spiral groove was formed on a surface of the urethane resin to form a polishing layer formed of a urethane resin having a size of 500 mm and a thickness of 1 mm. The blending amounts are shown in Table 2. Regarding the obtained polishing layer, the density was 0.8 g/cm³, the compression ratio was 0.7%, the D hardness was 55, and the hysteresis loss was 60%.

(Method of Producing CMP Laminated Polishing Pad)

The underlayer and the polishing layer obtained as described above were adhered to each other using a Hi-Bon YR713-1W (manufactured by Hitachi Kasei Polymer Co., Ltd., thickness: 80 μm) as a hot melt adhesive to obtain a CMP laminated polishing pad. Further, a double-sided tape was attached to a back surface of the CMP laminated polishing pad by using a pressure sensitive adhesive. The polishing rate of the obtained CMP laminated polishing pad was 2.3 μm/hr, and the scratch resistance thereof was 1.

### Comparative Examples 3 and 4

A CMP laminated polishing pad was prepared and evaluated in the same manner as in Examples except that the polymerization was carried out with the compositions shown in Table 2. Results are shown in Table 2.

TABLE 2

| Curable composition | | | | | | | | | | | |
|---|---|---|---|---|---|---|---|---|---|---|---|
| | | (A) | (B) | (D) | Another | Evaluation result | | | | | |
| | | Component | Component | Component | component | D | Compres- | | Hysteresis | Polishing | |
| | | (part by | (part by | (part by | (part by | hard- | sion ratio | Density | loss | rate | Scratch |
| | | mass) | mass) | mass) | mass) | ness | (%) | (g/cm³) | (%) | (μm/hr) | resistance |
| Example 20 | Underlayer | A-7 (13) | Pre-1 (85) | — | L5617 (1.5) | 16 | 7.0 | 0.7 | 3 | 2.3 | 1 |
| | | | TMP (2) | | | | | | | | |
| | Polishing | — | Pre-1 (88) | Hollow | — | 55 | 0.7 | 0.8 | 60 | | |
| | layer | | MOCA (12) | particles 1 | | | | | | | |
| | | | | (0.8) | | | | | | | |
| Comparative | Underlayer | — | Pre-1 (95) | — | L5617 (1.5) | 20 | 2.0 | 0.7 | 40 | 1.2 | 3 |
| Example 3 | | | TMP (5) | | | | | | | | |
| | Polishing | — | Pre-1 (88) | Hollow | — | 55 | 0.7 | 0.8 | 60 | | |
| | layer | | MOCA (12) | particles 1 | | | | | | | |
| | | | | (0.8) | | | | | | | |
| Comparative | Underlayer | — | | | | — | — | — | — | 1.0 | 5 |
| Example 4 | Polishing | — | Pre-1 (88) | Hollow | — | 55 | 0.7 | 0.8 | 60 | | |
| | layer | | MOCA (12) | particles 1 | | | | | | | |
| | | | | (0.8) | | | | | | | |

### Case of Application to Photochromic Cured Article; Acryl-Based

### Example 21

According to the following formulation, components were sufficiently mixed to prepare a photochromic curable composition.

### Formulation:

(A) component: A-5, 17 parts by mass

(B5) component: TMPT, 40 parts by weight

(B5) component: 14 G, 40 parts by mass

(B5) component: GMA, 1 part by mass

(C) component: PI, 0.3 parts by mass

(E) component: PC1, 3 parts by mass

(Others) stabilizer: HALS, 3 parts by mass

Next, a leveling agent and a radically polymerizable monomer were further added according to the following formulation, and uniform stirring and defoaming were carried out to obtain a photochromic curable composition. Blending ratios of the components are shown in Table 3.

### Formulation:

(Others) leveling agent: L7001, 0.1 parts by mass

(B5) radically polymerizable monomer: MOPMS, 2 parts by mass

A laminate including a photochromic cured article was obtained by using the photochromic curable composition according to the following method.

A thiourethane-based plastic lens having a center thickness of about 2 mm, a spherical power of −6.00 D, and a refractive index of 1.60 was prepared as an optical substrate. The thiourethane-based plastic lens was subjected to alkali etching at 50° C. for 5 minutes by using a 10% aqueous solution of sodium hydroxide in advance, and then was sufficiently cleaned with distilled water.

By using a spin coater (1H-DX2, manufactured by MIKASA), a surface of the plastic lens was coated with a moisture-curing primer (product name: TR-SC-P, manufactured by Tokuyama Co., Ltd.) at a rotational speed of 70 rpm for 15 seconds and then at 1,000 rpm for 10 seconds. Thereafter, about 2 g of the photochromic curable composition obtained as described above was used for spin-coating at a rotational speed of 60 rpm for 40 seconds and then at 600 rpm for 10 to 20 seconds, so that the thickness of the layer coated with the photochromic curable composition was 40 μm.

Therefore, the plastic lens coated with the photochromic curable composition was irradiated with light for 90 seconds by using a metal halide lamp having an output of 200 mW/cm² under a nitrogen gas atmosphere to cure the photochromic curable composition. Thereafter, the plastic lens was further heated at 110° C. for 1 hour to preapre a laminate in which the photochromic cured article was laminated.

The obtained laminate had an appearance evaluation in the coating method of 1, a maximum absorption wavelength of 590 nm, and photochromic properties including a coloring density of 0.97 and a fading speed of 45 seconds. The results are also shown in Table 3.

### Comparative Example 5

A laminate was prepared and evaluated in the same manner as in Example 21 except that the compositions shown in Table 3 were used. Results are shown in Table 3.

TABLE 3

| | | | | | | | Maximum | | |
|---|---|---|---|---|---|---|---|---|---|
| | | | | | | | absorption | | Fading |
| | (A) Component | (B5) Component | (C) Component | (E) Component | Additive | Appearance | wavelength | Coloring | speed |
| | (part by mass) | (part by mass) | (part by mass) | (part by mass) | (part by mass) | evaluation | (nm) | density | (sec) |
| Example 21 | A-5 (17) | TMPT (40)/14G | PI (0.3) | PC1 (3) | HALS (3) | 1 | 590 | 0.97 | 45 |
| | | (40)/GMA (1)/ | | | L1 (0.1) | | | | |
| | | MOPMS (2) | | | | | | | |
| Comparative | — | TMPT (40)/14G | PI (0.3) | PC1 (3) | HALS (3) | 4 | 590 | 0.97 | 45 |
| Example 5 | | (40)/GMA (1)/ | | | L1 (0.1) | | | | |
| | | MOPMS (2)/ | | | | | | | |
| | | RX-2 (17) | | | | | | | |

### Case of Application to Photochromic Cured Article; Urethane-Based

### Example 22

According to the following formulation, components were sufficiently mixed to prepare a photochromic curable composition.

### Formulation:

(A) component: A-1, 10 parts by mass

(B1) component: XDI, 33 parts by mass

(B3) component: PEMP, 36 parts by mass

(B6) component: PGME 10, 10 parts by mass

(B6) component: STMP, 11 parts by mass

(C1): Sn1, 0.05 parts by mass

(Others) component: HP, 0.3 parts by mass

(E) component: PC1, 1.9 parts by mass

A laminate including a photochromic cured article was produced by using the above photochromic curable composition according to the following bonding method. First, the photochromic curable composition was sufficiently defoamed, and then was injected into a glass plate having a gap of 1 mm and a mold formed of a thiourethane-based plastic lens having a refractive index of 1.60, and the photochromic curable composition was cured by cast polymerization. The curing was performed for 18 hours while gradually increasing the temperature from 27° C. to 120° C. by using an air furnace. After the curing, only the glass plate was taken out, and thereby a bonded type laminate in which a photochromic cured article having a thickness of 1 mm was laminated on the thiourethane-based plastic lens having a refractive index of 1.60 was obtained.

The obtained laminate had an appearance evaluation in the bonding method of 1, a maximum absorption wavelength of 593 nm, and photochromic properties including a coloring density of 0.95 and a fading speed of 65 seconds.

### Comparative Example 6

A laminate was prepared and evaluated in the same manner as in Example 22 except that compositions shown in Table 4 were used. Results are shown in Table 4.

TABLE 4

| | (A) Component | (B1) component | (B3) Component | (B6) Component | (C) Component | (E) Component |
|---|---|---|---|---|---|---|
| | (part by mass) | (part by mass) | (part by mass) | (part by mass) | (part by mass) | (part by mass) |
| Example 22 | A-1 (10) | XDI (33) | PEMP (36) | PGME 10 (10) | Sn1 (0.05) | PC1 (1.9) |
| | | | | STMP (11) | | |
| Comparative | — | XDI (33) | PEMP (36) | PGME 10 (10) | Sn1 (0.05) | PC1 (1.9) |
| Example 6 | | | RX-1 (10) | STMP (11) | | |

| | Additive | Appearance | Maximum absorption | Coloring | Fading speed |
|---|---|---|---|---|---|
| | (part by mass) | evaluation | wavelength (nm) | density | (sec) |
| Example 22 | HP (0.3) | 1 | 593 | 0.95 | 65 |
| Comparative | HP (0.3) | 2 | 593 | 0.95 | 60 |
| Example 6 | | | | | |

1. A curable composition comprising:
(A) a side chain-containing cyclic molecule in which three or more side chains each having a polymerizable functional group introduced at a terminal are introduced; and
(B) a polymerizable monomer having a polymerizable functional group polymerizable with the side chain-containing cyclic molecule.

2. The curable composition according to claim 1, wherein
a content of the (A) side chain-containing cyclic molecule in which three or more side chains each having a polymerizable functional group introduced at a terminal are introduced is 2 to 70 parts by mass with respect to 100 parts by mass in total of the (A) side chain-containing cyclic molecule in which three or more side chains each having a polymerizable functional group introduced at a terminal are introduced and the (B) polymerizable monomer having a polymerizable functional group polymerizable with the side chain-containing cyclic molecule.

3. The curable composition according claim 1, wherein
the side chains of the (A) side chain-containing cyclic molecule in which three or more side chains each having a polymerizable functional group introduced at a terminal are introduced have a molecular weight of 300 or more in terms of number average molecular weight.

4. The curable composition according to claim 1, wherein
the (A) side chain-containing cyclic molecule in which three or more side chains each having a polymerizable functional group introduced at a terminal are introduced has a cyclic molecule selected from the group consisting of a cyclodextrin and calix resorcinarene.

5. The curable composition according to claim 1, wherein
the (A) side chain-containing cyclic molecule in which three or more side chains each having a polymerizable functional group introduced at a terminal are introduced has a viscosity at 60° C. of 500 mPa·s to 50,000 mPa·s.

6. The curable composition according to claim 1, wherein
the polymerizable functional group in the (A) side chain-containing cyclic molecule in which three or more side chains each having a polymerizable functional group introduced at a terminal are introduced comprises a group selected from the group consisting of a hydroxy group, a thiol group, and an amino group, and
the (B) polymerizable monomer having a polymerizable functional group polymerizable with the side chain-containing cyclic molecule comprises a polymerizable monomer containing (B1) an iso(thio)cyanate compound having at least two iso(thio)cyanate groups in a molecule.

7. The curable composition according to claim 6, wherein
the (B1) iso(thio)cyanate compound having at least two iso(thio)cyanate groups in a molecule comprises an iso(thio)cyanate compound containing (B12) a urethane prepolymer having an iso(thio)cyanate group at both terminals of a molecule, the (B12) urethane prepolymer being obtained by reacting (B32) a bifunctional active hydrogen-containing compound having two active hydrogen-containing groups in a molecule with (B13) a bifunctional iso(thio)cyanate compound having two iso(thio)cyanate groups in a molecule.

8. The curable composition according to claim 7, wherein
the (B12) urethane prepolymer has an iso(thio)cyanate equivalent of 300 to 5,000.

9. The curable composition according to claim 1, further comprising:
(D) fine hollow particles.

10. The curable composition according to claim 9, wherein
the (D) fine hollow particles are fine hollow particles including an outer shell portion selected from the group consisting of a urethane resin and a melamine resin.

11. A cured article obtained by curing the curable composition according to claim 1.

12. The cured article according to claim 11, wherein
the cured article is a foamed cured article.

13. A polishing pad comprising:
the cured article according to claim 11.

14. A CMP laminated polishing pad using the cured article according to claim 12 for a polishing layer and/or an underlayer.

15. A CMP laminated polishing pad using the cured article according to claim 11 for an underlayer.

16. The curable composition according to claim 1, further comprising:
(E) a photochromic compound.

17. The curable composition according to claim 16, wherein
the photochromic compound is a compound having one or more structures selected from the group consisting of a naphthopyran, a spirooxazine, a spiropyran, a fulgide, a fulgimide, and a diarylethene.

18. The curable composition according to claim 16, wherein
the polymerizable functional group in the (A) side chain-containing cyclic molecule in which three or more side chains each having a polymerizable functional group introduced at a terminal are introduced is a group selected from the group consisting of a hydroxy group, a thiol group, an amino group, an acrylic group, a methacrylic group, an allyl group, and a vinyl group.

19. A photochromic cured article obtained by curing the curable composition according to claim 16.
